(19) United States
(12) Patent Application Publication
(10) Pub. No.: US 2003/0149759 A1
(43) Pub. Date: Aug. 7, 2003

(54) System and method for administering life safety programs

(76) Inventors: Brent Taylor Hetherington, Nolensville, TN (US); James Robert Hendrick III, Nashville, TN (US)

Correspondence Address: WADDEY & PATTERSON, 414 UNION STREET, SUITE 2020, BANK OF AMERICA PLAZA, NASHVILLE, TN, 37219

(21) Appl. No.: 10/287,422

(22) Filed: Nov. 4, 2002

Related U.S. Application Data
(60) Provisional application No. 60/336,392, filed on Nov. 2, 2001.

(51) Int. Cl. G06F 15/173

(52) U.S. Cl. 709/223

(57) ABSTRACT

A computer system and method for managing maintenance, operation, and program implementation requirements for specialized equipment used by laypersons to provide assistance to individuals until professional assistance can arrive. The computer system includes a database module for storing maintenance, operation, and program implementation requirement information and actual maintenance, operation, and program implementation information for various pieces of specialized equipment. The computer system also includes a maintenance module that is operable to compare the actual information with the required information to determine if the various pieces of specialized equipment are being properly maintained and operated, and if programs associated with the various pieces of specialized equipment are being properly implemented. If not, the maintenance module generates a communication to the user indicating that fact and provides the user with information regarding the proper procedure to follow to bring the specialized equipment into compliance with requirements.

### BACKGROUND OF THE INVENTION

The present invention relates generally to systems and methods for administering life safety programs. More particularly, this invention pertains to a system and method for administering life safety programs that monitors and ensures compliance with life safety program requirements. Still more particularly, this invention relates to a system and method that monitors and ensures proper life safety training and/or certification for personnel participating in life safety programs and/or monitors and ensures proper life safety equipment and consumables maintenance.

Life Safety Programs, such as Automated External Defibrillation (AED) and Public Access Defibrillation (PAD) Programs, have been recognized as beneficial with regard to saving the lives of individuals suffering from sudden cardiac arrest and other medical emergencies. These programs are designed to provide laypersons, as well as medical professionals, with the knowledge and technology necessary to provide life-saving assistance to individuals suffering sudden cardiac arrest or other medical emergencies until professional medical help can arrive. Similar programs used in other fields, such as the environmental and health and safety fields, are designed to provide similar functions. In other words, there are similar programs that supply training and specialized equipment to laypersons and medical professionals that can be used by those persons to provide some type of assistance to an individual or individuals until professional assistance can arrive.

Companies administering life safety programs and providing life safety equipment, or administering other types of similar programs and providing other types of specialized equipment, however, may be liable for harm caused by improper personnel training relating to life saving procedures, e.g., CPR, first aid, personnel training relating to operation of life safety equipment, training of the personnel training the personnel performing life saving procedures or operating life saving equipment, i.e., training the trainer, equipment maintenance, and equipment consumables maintenance. While many states have Good Samaritan legislation that exempt such companies from most liability, the exemption only applies if certain requirements are complied with. For example, in some states, the exemption does not apply if the equipment is not properly maintained or the equipment consumables, e.g., in the case of life safety equipment, pads, batteries, etc., are exhausted or used after their expiration date. In other states, the exemption does not apply if the personnel performing life saving procedures or operating the life safety equipment are not properly trained and certified to perform those procedures or operate the life safety equipment. In still others, the exemption does not apply if the personnel training the personnel performing the life saving procedures or operating the life safety equipment are not properly trained and certified to provide that training.

To further complicate matters, failure to properly maintain equipment or to operate that equipment with properly trained and certified personnel can relieve the equipment manufacturer from any liability for the failure of that equipment. Many equipment manufacturers have required maintenance requirements for their equipment and required training and certification requirements for personnel operating that equipment. Failure to comply with these maintenance and training requirements can relieve the manufacturer of liability for the failure of that equipment.

It is very desirable for companies administering life safety programs and supplying life safety equipment, and administering other programs and supplying other types of specialized equipment, to ensure that they will receive the protection of the applicable Good Samaritan legislation in the jurisdictions within which they operate and to ensure that the equipment manufacturers remain liable for their equipment. Unfortunately, there are no known systems that can be used to monitor and ensure proper life safety training and/or certification of personnel participating in life safety programs and monitor and ensure proper life safety equipment and consumables maintenance.

What is needed, then, is a system and method for monitoring and ensuring proper life safety training and/or certification of personnel participating in life safety programs and monitoring and ensuring proper life safety equipment and consumables maintenance.

### SUMMARY OF THE INVENTION

Accordingly, one object of the present invention is to provide a system and method for monitoring and ensuring proper life safety training and/or certification of personnel participating in life safety programs.

Another object is to provide a system and method for automatically prompting a user when personnel life safety training and/or certification is required or recommended.

Another object of the present invention is to provide a system and method for monitoring and ensuring proper maintenance of equipment used in life safety programs.

Another object is to provide a system and method for automatically prompting a user when equipment maintenance is required or recommended.

Still another object of the present invention is to provide a system and method for monitoring and ensuring proper maintenance of equipment consumables used in life safety programs.

Yet another object is to provide a system and method for automatically prompting a user when equipment consumables maintenance is required or recommended.

These and other objects, which will become clear to someone practicing the present invention, are satisfied by the present invention. The present invention is a computer system that can be used for third party data administration of programs with potential liability associated with improper equipment maintenance and implementation. These programs generally include equipment, program-related consumables, and/or trained/certified skilled program implementers. The computer system of the present invention includes a database module for storing information regarding life safety program and equipment requirements. More specifically, the database module is operable to store information regarding life safety procedure training requirements, e.g., CPR, basic first aid, etc., life safety equipment maintenance and operation training requirements, life safety equipment consumables maintenance, life safety program trainer requirements, i.e., training requirements for personnel responsible for training the personnel that perform CPR or operate life safety equipment. The computer system of the present invention also includes a training and maintenance module in communication with the database module that is operable to automatically review the information in the database module and determine if the any personnel training, equipment maintenance, or consumables maintenance is recommended or required. If so, the training and maintenance module generates and transmits a prompt indicating that fact to the appropriate user. The training and maintenance module can also provide information regarding the required or recommended training, equipment maintenance, or consumables maintenance, and further, can facilitate the completion of any required actions.

The present invention can be used with programs involving equipment having manufacturer's requirements and/or recommendations regarding equipment maintenance to ensure compliance with these requirements or recommendations. Compliance ensures that the manufacturers remain liable for equipment performance. The present invention can be used with programs involving consumables with or without expiration dates required for proper execution of the equipment and/or these programs. The present invention can be used with programs that require training and/or certification of human resources on various types of specialized equipment in order to maintain manufacturer liability or to receive exemption from liability via appropriate Good Samaritan-type legislation. The present invention can be used with programs that require training and/or certification on the skills required in the implementation of these programs in order to receive exemption from liability via appropriate Good Samaritan-type legislation.

Some of the primary uses of the present invention include use as a Program management tool, a Risk management tool, a Continuous Quality Improvement (CQI) tool/Quality Management tool, an Accreditation/Compliance management tool, a Marketing tool, a Customer Relationship Management (CRM) tool, a communications tool, a media tool, and a Public Relations (PR) tool.

The present invention has a variety of features. For example, the present invention tracks and maintains training/certification personnel records for individual personnel. The present invention monitors and issues prompts to users when personnel training/certification is recommended or required and when insufficient personnel exist to meet program needs or readiness thresholds. The present invention provides training request and scheduling capabilities, options for personal training sessions and/or distance learning as applicable, and training/certification documentation fulfillment from various organizations. The present invention can be used to log equipment maintenance and/or status records and to provide prompts to users when maintenance and/or status records are incomplete and/or not filed in a timely manner. The present invention can be used to log equipment use records and to provide prompts when equipment use records are incomplete and/or not filed in a timely manner. The present invention can be used to track and maintain consumable goods, to issue prompts to users when consumable goods supplies are low, lacking, and/or are nearing/at the end of their life span, and as an ordering interface for ordering consumables.

The present invention also provides a centralized database of trained/certified personnel, provides a rapid notification system for product recalls based on lot number, model number, serial number or other data maintained in data records, and provides a queue of actionable tasks for maintaining a program with the elements of equipment, consumables and/or training. The present invention prompts users with appropriate responses to actionable and provides related data records, provides varying levels of access (access to varying sections and read/write privileges) for different types of users. The present invention notifies users of changes in legislation that may affect their program and automatically populates client inventory records when a client's order ships. The present invention prompts clients/users and/or implementers to confirm receipt of orders, order data (e.g., lot numbers, serial numbers, model numbers, expiration dates, install by dates, check on dates, etc.), and allocates order inventory to specific equipment and/or locations. In summary, then, the present invention integrates, into a single interface, program implementation protocols, maintenance logs, usage logs, ordering, service, legal requirements, and training.

In one embodiment, the present invention is used with programs such as the Public Access to Defibrillation (PAD) and Life Safety and Emergency Medical Systems (EMS) Programs, both of which involve medical equipment managed and/or executed by laypersons and/or clinical persons. In this embodiment, the present invention is used to provide a centralized national and international database and registry of Public Access to Defibrillation (PAD) and Life Safety Programs for EMS, 911 systems and other emergency medical systems. This embodiment enables Medical Director Program Oversight in a single interface and integrates key elements required for proper medical direction and implementation of PAD Programs and Life Safety Programs according to American Heart Association, Red Cross, American Safety Institute (ANSI), Occupational Safety and Health Agency guidelines, as well as according to local, state, national, and international guidelines and requirements. This embodiment also includes a needs assessment algorithm for determining program needs on a facility basis.

### BRIEF DESCRIPTION OF THE DRAWINGS

FIG. 1 is a block diagram of one embodiment of the present invention.

FIG. 2 is a flow chart showing an overview of the passive mode operation of one embodiment of the present invention.

FIG. 3 is a flow chart showing the program implementation routine of one embodiment of the present invention.

FIG. 4 is a flow chart showing the equipment reporting routine of one embodiment of the present invention.

FIG. 5 is a flow chart showing the equipment return to service routine of one embodiment of the present invention.

FIG. 6 is a flow chart showing the ordering routine of one embodiment of the present invention.

FIG. 7 is a flow chart showing the training records routine of one embodiment of the present invention.

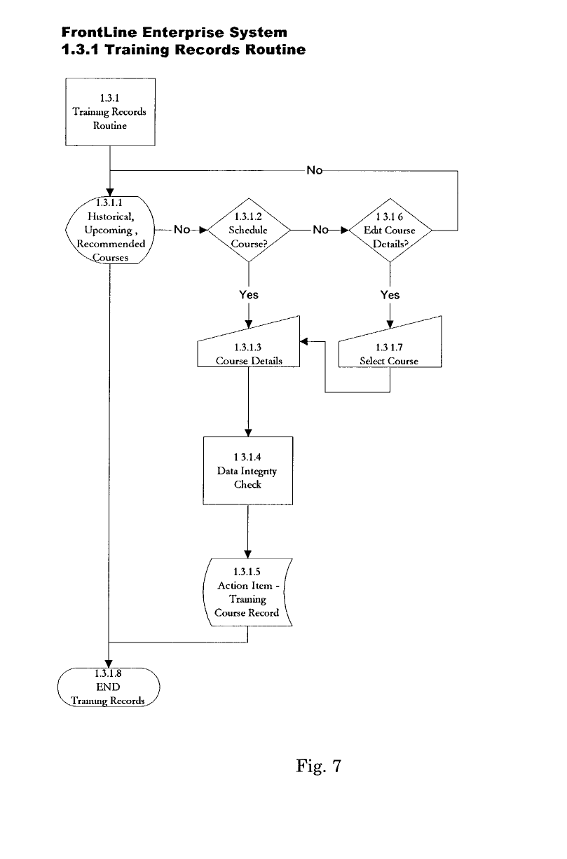

FIG. 8 is a flow chart showing the equipment records routine of one embodiment of the present invention.

FIG. 9 is a flow chart showing the staff maintenance routine of one embodiment of the present invention.

FIG. 10 is a flow chart showing the MD/EMS records routine of one embodiment of the present invention.

FIG. 11 is a flow chart showing the maintain preferences records routine of one embodiment of the present invention.

FIG. 12 is a flow chart showing the action items routine of one embodiment of the present invention.

FIG. 13 is a flow chart showing an overview of the active mode operation of one embodiment of the present invention.

FIG. 14 is a flow chart showing the check equipment usage records routine of one embodiment of the present invention.

FIG. 15 is a flow chart showing the check equipment maintenance records routine of one embodiment of the present invention.

FIG. 16 is a flow chart showing the check equipment consumables records routine of one embodiment of the present invention.

FIG. 17 is a flow chart showing the check staff certification records routine of one embodiment of the present invention.

FIG. 18 is a block diagram of a client-server embodiment of the present invention.

FIG. 19 is a block diagram of an Internet-enabled, client-server embodiment of the present invention.

### DESCRIPTION OF THE PREFERRED EMBODIMENTS

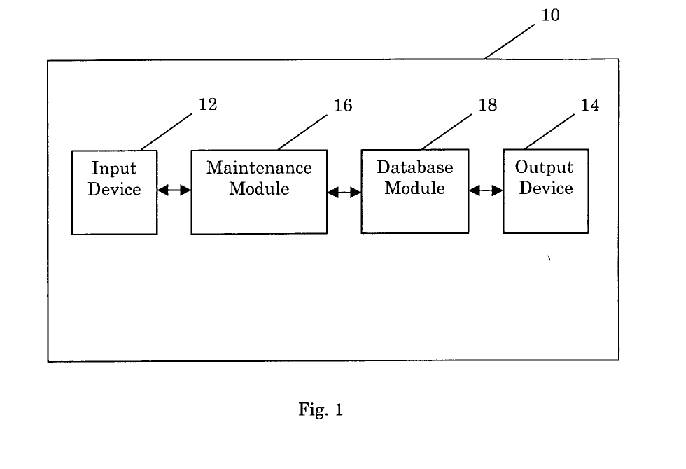

Referring to FIG. 1, one embodiment of the present invention includes a computer system 10 having an input device 12, an output device 14, a maintenance module 16, and a database module 18. The input device 12 is operable to input information into the computer system 10 and the output device 14 is used to output information from the computer system 10. The input device 12 shown in FIG. 1 includes a conventional keyboard and mouse and the output device 14 includes a conventional display. In alternative embodiments, the input device 12 may include other types of input devices that can be used to input information into the computer system 10 and the output device 14 may include other types of output devices that can be used to output information from the computer system 10.

The database module 18 is operable to store initialization information and client specific information. Initialization information is required to initialize the system for a particular program application and includes the following parameters: intervals for regularly scheduled activities (i.e. reporting logs, training frequency, etc.), ranges for equipment readings, training types, certification types, etc. Client specific information is required to initialize the system for specific client use and includes initial data values for equipment (i.e. brand, model, serial number, “check on” date), equipment consumables (i.e. serial number, lot number, model number, “expiration date,” “install by date,” etc.) and/or training/certification (i.e. names of certified resources, certification dates, certification types, shift, resource location/allocation, etc.).

The database module 18 is also operable to store information relating to the maintenance, operation, and program implementation requirements associated with specialized equipment and to store information relating to the actual maintenance, operation, and program implementation associated with that equipment. For example, the database module 18 is operable to store program-related reports, such as equipment maintenance/monitoring log or checklists, equipment usage reports, equipment post use instruction reports, equipment return to service reports, and program protocols (stored as read-only documents).

The maintenance module 16 is operable to compare the actual information to the requirement information to determine if the specialized equipment is being properly maintained, can be properly operated, and to determine if the program associated with the specialized equipment can be properly implemented. If the maintenance module determines that the specialized equipment is not properly maintained or cannot be properly operated, or that the program associated with the specialized equipment cannot be properly implemented, the maintenance module generates and outputs a communication indicating that fact. The communication from the maintenance module includes information identifying a problem associated with the implementation of the program associated with the specialized equipment, and information identifying the proper procedure to correct that problem. A user receiving the communication can then respond appropriately and correct the problem.

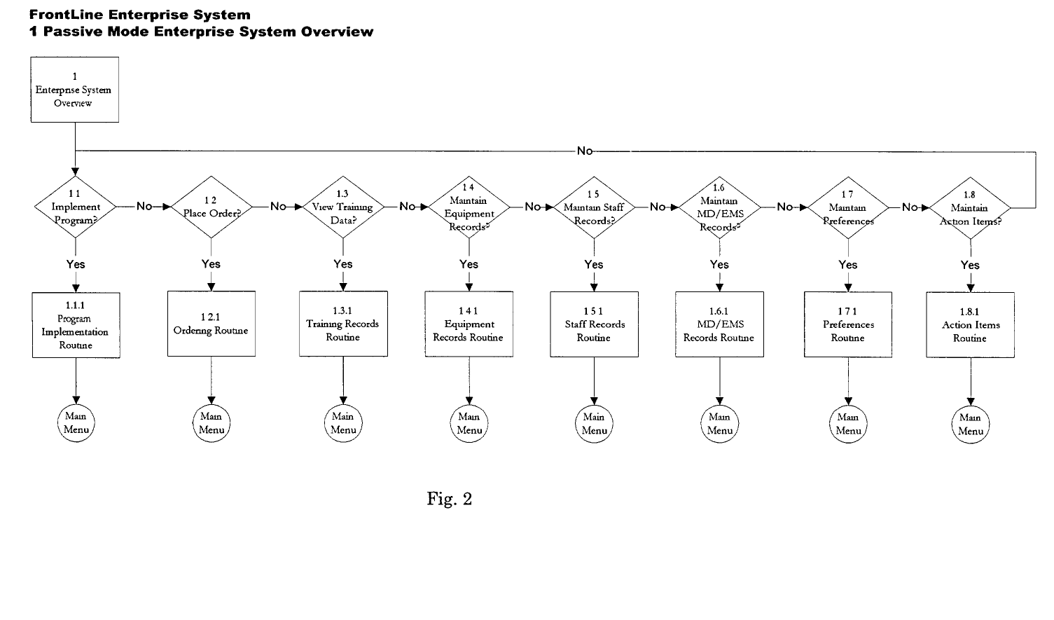

The maintenance module 16, and accordingly the system 10, can be operated in a passive mode and/or an active mode. In the passive mode, a user can log in directly or via a network connection (i.e. LAN, WAN, wireless, infrared, Internet, Cell Phone, PDA, etc.) to access the system 10. In active mode, the system 10 may prompt the user via a selected and prioritized communications link (i.e. E-Mail, Instant Messaging, Phone, Beeper/Pager, PDA, etc.). In the passive mode, users access the system 10 using a main menu and select from a series of activities, 1.1 through 1.8 (see FIG. 2).

Passive Mode Operation

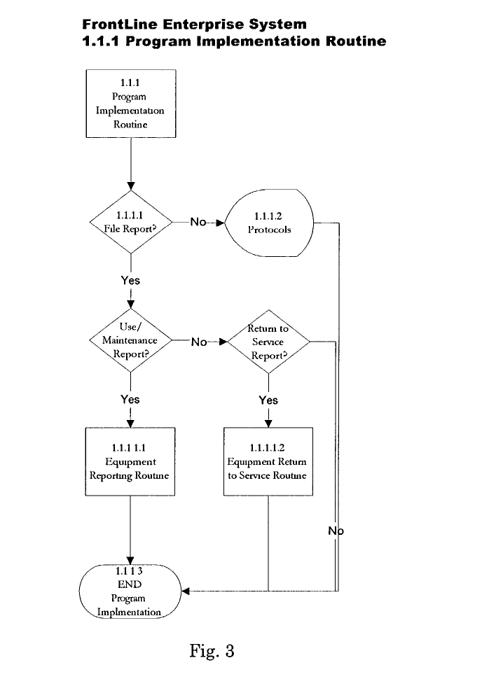

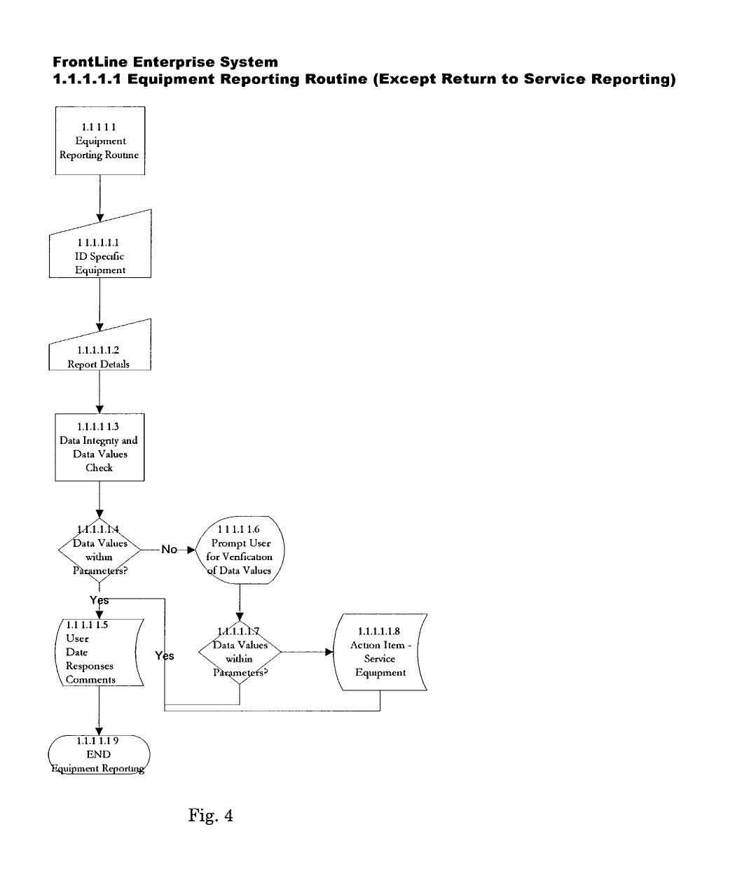

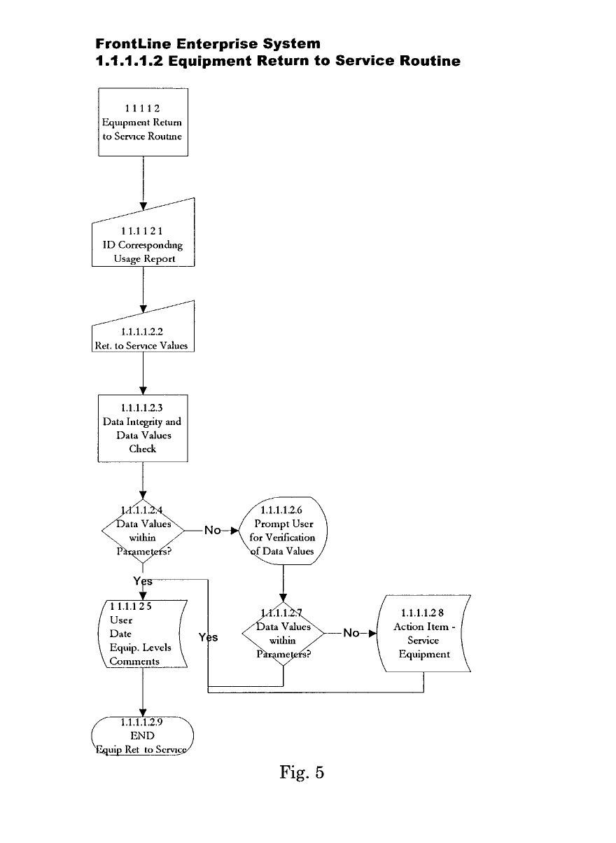

Referring to FIGS. 2-5, implementation of the program is accomplished through the system interface (1.1.1). Within program implementation records, users may file program-related reports (1.1.1.1)—equipment maintenance/monitoring log or checklist, equipment usage, equipment post use instructions, and equipment return to service reports. Users may also view program protocols (1.1.1.2) as read-only documents.

All reports, except return to service reports, go through a subroutine for data input and validation (1.1.1.1.1). Within that routine, the specific equipment utilized is identified (1.1.1.1.1.1) and the report data is entered (1.1.1.1.1.2). The data undergoes a data integrity check and values are checked against acceptable ranges (1.1.1.1.1.3). If the data values are within acceptable parameters, the data is logged (1.1.1.1.1.5) and the subroutine completed (1.1.1.1.1.9). If the data does not fall within the acceptable ranges, the user is prompted to verify the data input (1.1.1.1.1.6). The data is checked again for validity. If within acceptable ranges, the data is logged (1.1.1.1.1.5), otherwise an action item is created to prompt the user and/or third party data administrator's representative regarding the unacceptable data values (1.1.1.1.1.8) before storing the data (1.1.1.1.1.5) before ending the subroutine (1.1.1.1.1.9).

Return to Service Reports are associated with a Usage Report or Maintenance Report. Return to Service Reports go through a subroutine for data input and validation (1.1.1.1.2). Within that routine, the specific Usage Report or Maintenance Report with which the Return to Service Report is associated is identified simultaneously identifying the associated equipment (1.1.1.1.2.1) and the report data is entered (1.1.1.1.2.2). The data undergoes a data integrity check and values are checked against acceptable ranges (1.1.1.1.2.3). If the data values are within acceptable parameters, the data is logged (1.1.1.1.2.5) and the subroutine completed (1.1.1.1.2.9). If the data does not fall within the acceptable ranges, the user is prompted to verify the data input (1.1.1.1.2.6). The data is checked again for validity. If within acceptable ranges, the data is logged (1.1.1.1.2.5), otherwise all action item is created to prompt the user and/or third party data administrator's representative regarding the unacceptable data values (1.1.1.1.2.8) before storing the data (1.1.1.1.2.5) before ending the subroutine (1.1.1.1.2.9).

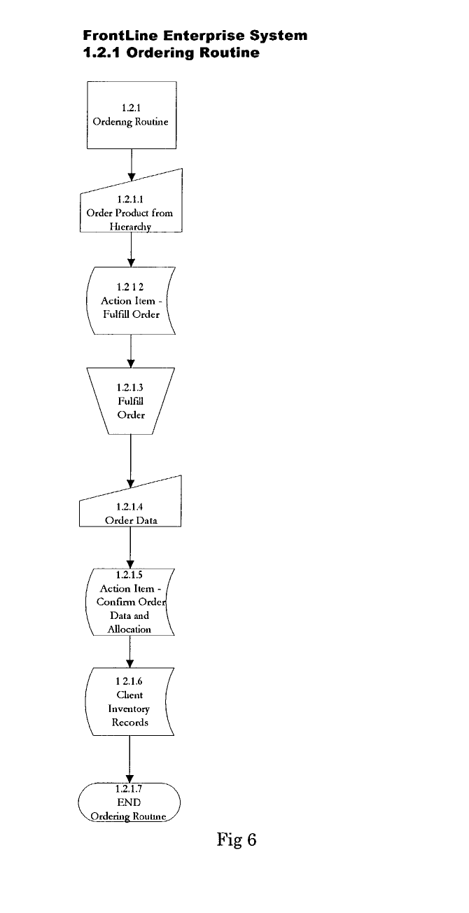

Referring to FIGS. 2 and 6, placing an order for equipment or consumables uses a subroutine that manages and logs order information and client inventory allocation (1.2.1). Orders are placed through a hierarchy of products divided into categories (1.2.1.1). Placement of an order triggers an actionable task (1.2.1.2) which is manually or automatically fulfilled by an automated external system (1.2.1.3). Order data (i.e. quantities, serial numbers, lot numbers, model numbers, expiration dates, install by dates, check on dates, etc.) is stored and logged (1.2.1.4). Entry of order information triggers an additional actionable item to prompt the client/user to confirm receipt of the order, verify the order data and allocate the equipment and/or location to which the order items are associated (1.2.1.5). Client inventory records are updated with the new order information (1.2.1.6) before the subroutine terminates (1.2.1.7).

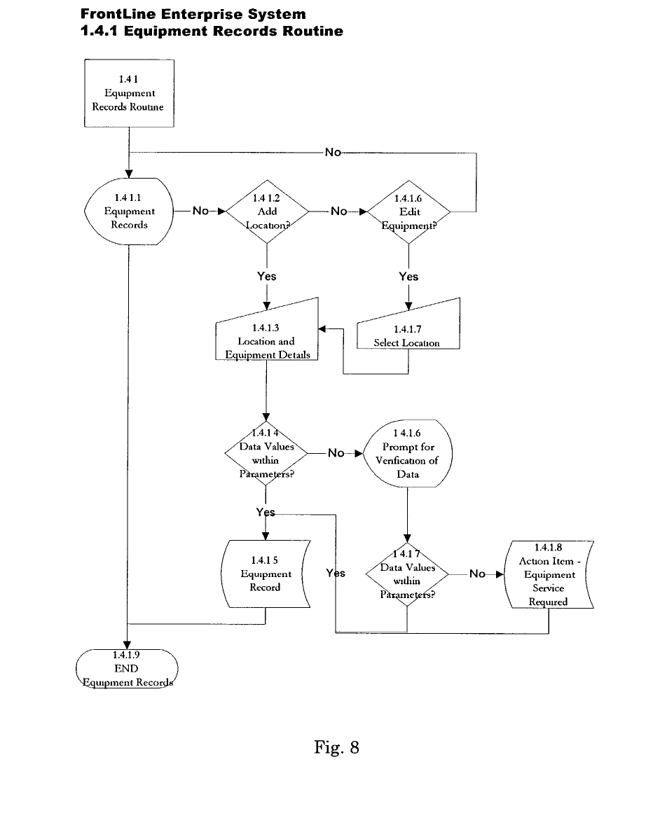

Referring to FIGS. 2 and 8, training records are managed through a system subroutine (1.3.1). An initial display provides an overview of historical and upcoming training sessions as well as a prompt for projected future training needs (1.3.1.1). Users may request/schedule a course (1.3.1.2) by providing training request data (1.3.1.3) which is confirmed by the training services provider. The data undergoes a data integrity check (1.3.1.4) before triggering an actionable task to confirm the requested training schedule (1.3.1.5) and terminating the subroutine (1.3.1.8). Select users have the ability to edit course details (1.3.1.6) by first selecting the course (1.3.1.7) and providing training request data (1.3.1.3) which is confirmed by the training services provider. The data undergoes a data integrity check (1.3.1.4) before triggering an actionable task to confirm the requested training schedule (1.3.1.5) and terminating the subroutine (1.3.1.8).

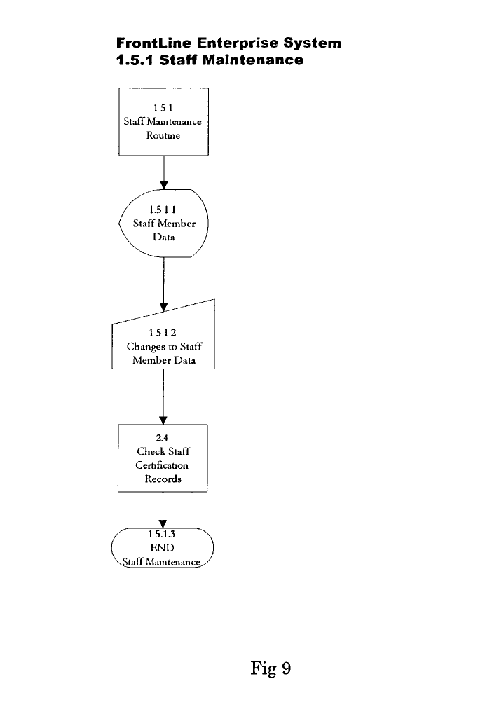

Referring to FIGS. 2 and 9, equipment records are maintained through the system (1.4.1). An initial display provides an overview of the equipment installations/locations (1.4.1.1). Select users may add locations (1.4.1.2) by providing data values for a new location (1.4.1.3). If data values are within parameters in the system (1.4.1.4) the equipment records are updated (1.4.1.5) before the subroutine terminates (1.4.1.9). If the values are not within the set parameters, the user is prompted to verify the values (1.4.1.6). If the values are within parameters (1.4.1.7), the data is recorded in the client record (1.4.1.5) before the subroutine terminates (1.4.1.9). If the values continue to be outside of the set parameters, an action item is triggered to service or review the equipment and its data (1.4.1.8) before the data is recorded (1.4.1.5) and the subroutine terminates (1.4.1.9).

Select users may edit equipment data (1.4.1.6) by selecting the data to edit within a specific equipment location (1.4.1.7). The user inputs new data values (1.4.1.3). If data values are within parameters in the system (1.4.1.4) the equipment records are updated (1.4.1.5) before the subroutine terminates (1.4.1.9). If the values are not within the set parameters, the user is prompted to verify the values (1.4.1.6). If the values are within parameters (1.4.1.7), the data is recorded in the client record (1.4.1.5) before the subroutine terminates (1.4.1.9). If the values continue to be outside f the set parameters, an action item is triggered to service or review the equipment and its data (1.4.1.8) before the data is recorded (1.4.1.5) and the subroutine terminates (1.4.1.9).

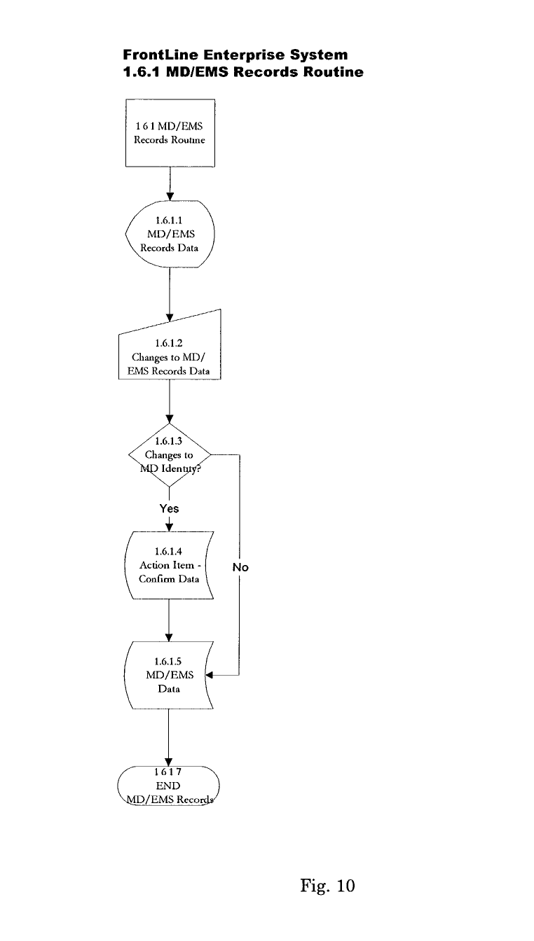

Referring to FIGS. 2 and 10, trained/certified staffing resources are maintained through the system (1.5.1). An initial interface displays resource-by-resource attributes (1.5.1.1). Changes are input into the system (1.5.1.2) and undergo a subroutine data integrity check identical in function to the check used in the active mode of the system (reference subroutine 2.4) before terminating the subroutine (1.5.1.3).

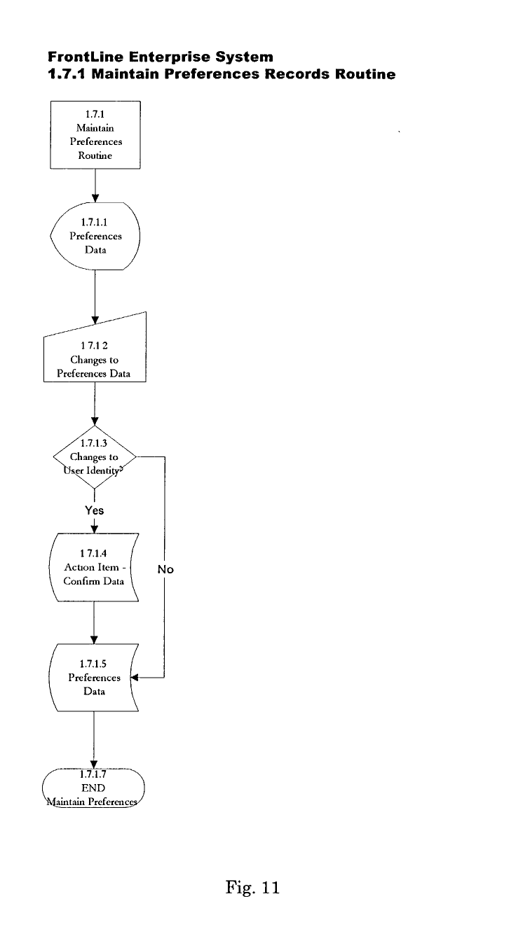

Referring to FIGS. 2 and 11, MD and EMS data are maintained through the system (1.6.1). MD and EMS data is displayed in an initial interface (1.6.1.1). Users have varying degrees of privileges to change MD and EMS data. Changes are made (1.6.1.2). If changes are to MD identity fields (1.6.1.3) an action item for the third party administrator to confirm manually the data is triggered (1.7.1.4). The data is checked for integrity before updating the data record (1.7.1.5) and terminating the subroutine (1.7.1.6). If the MD identity data is unchanged (1.7.1.3) the data is checked for integrity and stored (1.7.1.5) before terminating the subroutine (1.7.1.6).

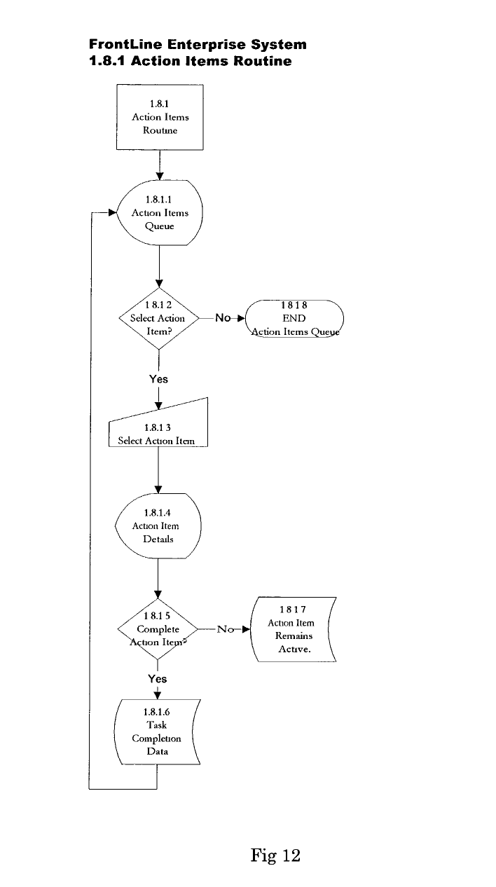

Referring to FIGS. 2 and 12, user preferences are maintained through the system (1.7.1). Preferences data is displayed in an initial interface (1.7.1.1). Changes are made (1.7.1.2). If changes are to user identity fields (1.7.1.3) an action item for the third party administrator to confirm manually the data is triggered (1.7.1.4). The data is checked for integrity before updating the user preferences record (1.7.1.5) and terminating the subroutine (1.7.1.6). If the user identity data is unchanged (1.7.1.3) the data is checked for integrity and stored (1.7.1.5) before terminating the subroutine (1.7.1.6).

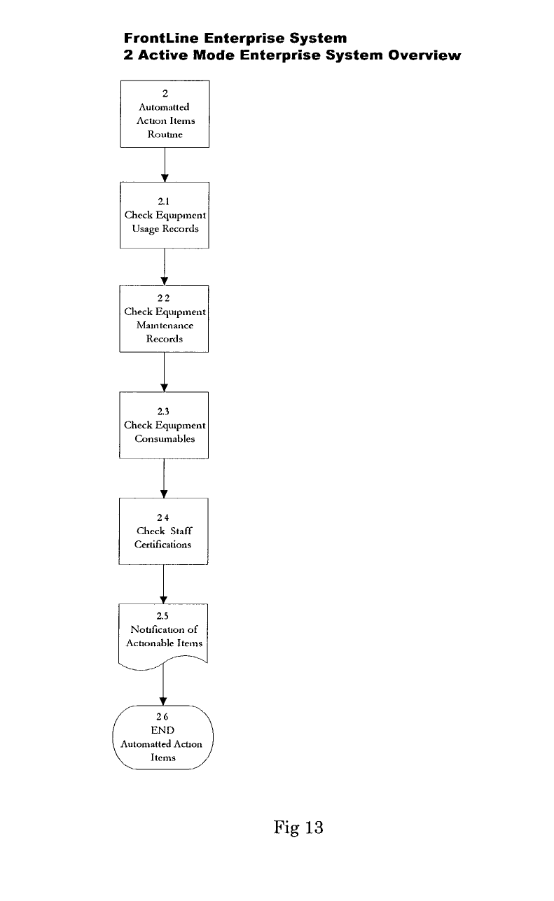

Referring to FIGS. 2 and 13, action items are maintained through the system interface (1.8.1). The system displays a series of action items generated by the system (1.8.1.1) based on client input values received through reports or input as values in maintaining equipment (i.e. consumable goods lot numbers, serial numbers, model numbers, expiration dates, install by dates, check on dates, etc.). The user selects an action item (1.8.1.3) and the system displays the required/recommended action including related data such as report data, equipment data and/or related human resources data (1.8.1.4). The user acknowledges the action item and inactivates the actionable task by performing the task and recording the performance of the task in the data records (18.1.6). Failure to complete the task leaves the task active and viewable (1.8.1.6). The subroutine terminates (1.8.1.8) when there are no more active actionable items.

Active Mode Operation

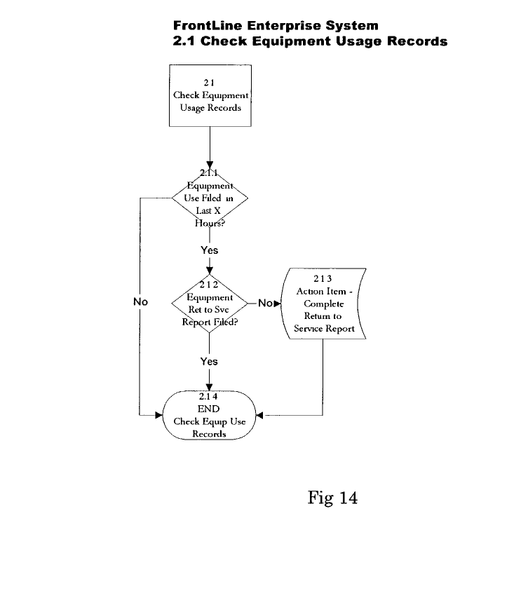

Referring to FIG. 14, users are prompted by the system via various communication methods to take action regarding their program (2). An actionable set of program tasks is accumulated through a periodic scheduled review of program data values against established program parameters (2.1 through 2.5). The accumulated list is sent to the user (2.5) via one of or a series of prioritized methods including E-Mail, Instant Messaging, Phone, Beeper/Pager, PDA, etc. The messages may be disseminated individually based on each instance of an actionable task or may be batched and sent in a single periodic communication either regularly scheduled or sent on exception.

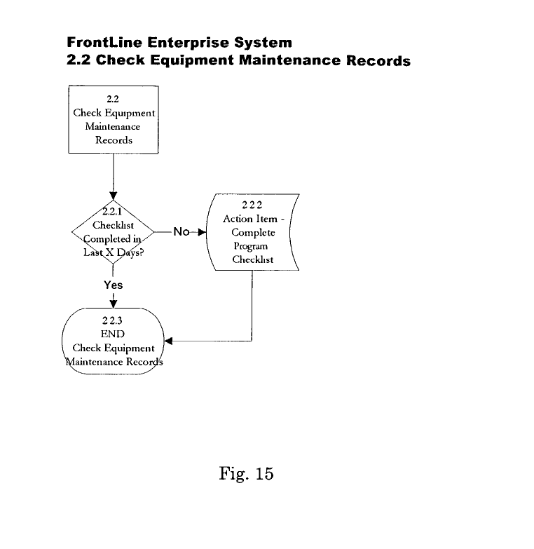

Referring to FIG. 15, the system checks equipment usage records (2.1). If the system finds recent activity (2.1.1), the system searches for appropriate associated follow up documentation in the form of a timely filed Return to Service Report (2.1.2). Finding an appropriate Return to Service Report, the subroutine terminates (2.1.4) Failing an appropriate Return to Service Report, an actionable task to complete the report is recorded (2.1.3) before the subroutine terminates (2.1.4).

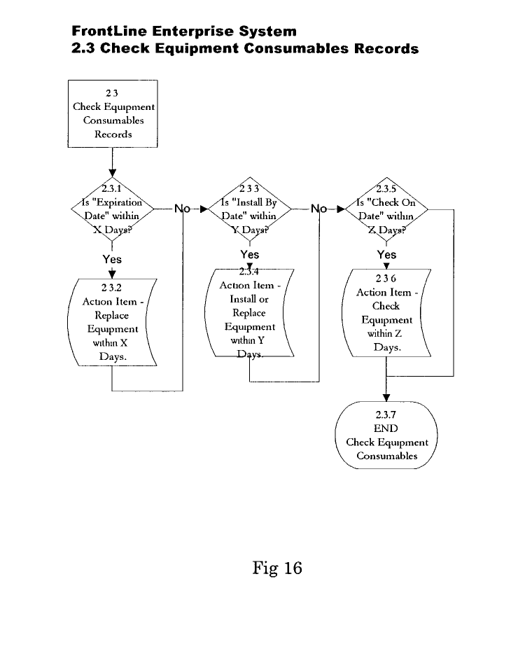

Referring to FIG. 16, the system checks equipment maintenance records (2.2). The system checks that reports are periodically filed in accordance with the schedule for the client. (2.2.1). If the program maintenance logs have been filed according tot he parameters established for the client, the subroutine terminates (2.2.3). If the reports are not filed in accordance with the schedule for the client, an actionable task to compete the report is recorded (2.2.2), and the subroutine terminates (2.2.3).

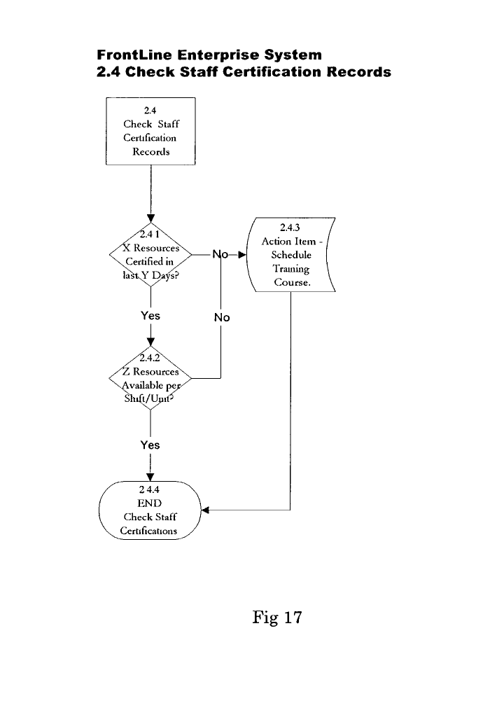

Referring to FIG. 17, the system checks consumable goods records (2.3). The system checks that consumable goods' “expiration dates” are within the parameters acceptable for the client (2.3.1). If not, an actionable task to replace the goods with dates outside of the acceptable parameters if recorded (2.3.2). The system checks that consumable goods' “install by” dates are within the parameters acceptable for the client (2.3.3). If not, an actionable task to replace the goods with dates outside of the acceptable parameters is recorded (2.3.4). The system checks that consumable goods' “check on” dates are within the parameters acceptable for the client (2.3.5). If not, an actionable task to replace the goods with dates outside of the acceptable parameters is recorded (2.3.6). The subroutine terminates (2.3.7).

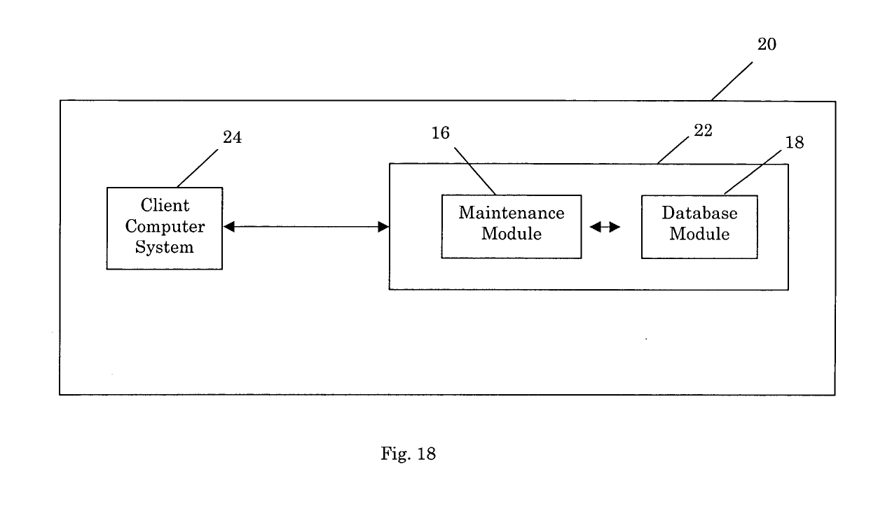

Referring to FIG. 18, the system checks staff records (2.4). The system checks that sufficient staff has training/certification within an established period of time for the client (2.4.1) and that sufficient staff resources exist to meet the scheduling of the client and the available locations of equipment (2.4.2). If staffing is insufficient in any given area, an actionable task to schedule training is recorded (2.4.3). Otherwise the subroutine terminates (2.4.4).

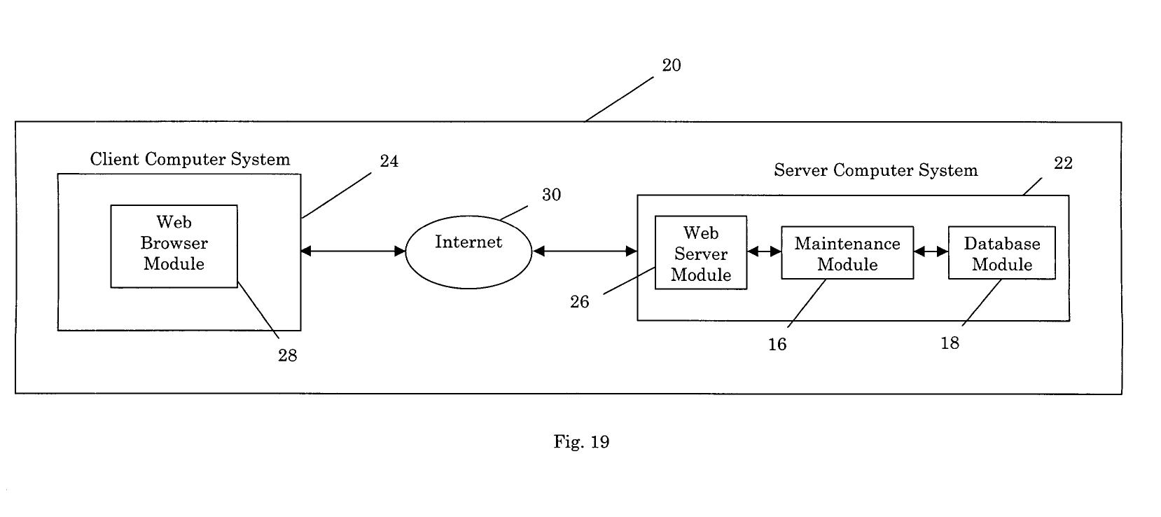

Referring to FIG. 19, in a client-server embodiment of the present invention, the computer system 20 includes a server computer system 22 and one or more client computer systems 24. The server computer system 22 houses the database module 18 and the maintenance module 16 and the client computer system 24 houses conventional software and hardware that can be used to communicate with the server computer system 22. The client computer systems 24 can be located at one or more remote locations with respect to the server computer system 22.

Referring to FIG. 20, in an Internet-enabled, client-server embodiment of the present invention, the server computer system 22 includes a web server module 26, in addition to the database module 18 and the maintenance module 16, and the client computer system 24 includes a web browser module 28 that can be used to communicate with the server computer system 22 using the web server module 26 and the Internet 28. Once again, the client computer systems 24 can be located at one or more remote locations with respect to the server computer system 22.

Various modifications can be made to the present invention described above. For example, the server computer system can be implemented using Microsoft's Windows 2000 Advanced Server software, the database module can be implemented using Microsoft's SQL Server 2000 software, and the web server module can be implemented using Microsoft's Internet Information Server 5.0 software. The server computer system can be separated into two separate server systems: a web server computer system and a database server computer system. In such an embodiment, the web server computer system can be implemented using Microsoft's Windows 2000 Advanced Server software and Microsoft's Internet Information Server 5.0 software. In a similar manner, the database server computer system can be implemented using Microsoft's Windows 2000 Advanced Server software and Microsoft's SQL Server 2000 software. The web browser software module on the client computer system can be implemented using Netscape's web browser software or Microsoft's Internet Explorer, version 4.x or higher. In addition, the web browser software can be compatible with DHTML or XML/XSLT (in order to facilitate data exchange with other platforms). The equipment software module can be implemented using ASP 3.0 web scripting and XML. The equipment software module can also be implemented using Microsoft's .net programming language to further enhance the portability of the equipment software module among different platforms. The equipment software module can be implemented so that it is portable with WindowsNT, UNIX, LINUX, and all ODBC compliant database solutions, such as Oracle and MySQL. The computer system of the present invention can also be implemented with various data security and data integrity measures in place. For example, the system can be implemented with UserID/Password combination and 128-bit SSL encryption to ensure data security. To ensure data integrity, the system operating procedures require regularly scheduled backups of the system and the database to DAT, CD-ROM, or other similar storage media.

Implemented Versions of the Present Invention

The applicant has implemented two versions of the present invention for use with AED and Oxygen delivery equipment. Detailed descriptions of each are included below.

Overview of Version 1.0

FrontLine is a provider of life-safety training courses and services and the associated life safety equipment (i.e. AEDs, Oxygen, etc.). FrontLine is a customer service oriented business relying on software solutions and hard-copy documentation for the organization and management of its customer service efforts.

The existing FrontLine effort is comprised of multiple off the shelf software packages each suitable in their own right for the purpose(s) to which they are tasked and a series of internally developed hard-copy forms. Since multiple software solutions are used and various forms capture redundant information, duplicate data is entered and maintained in multiple systems. This requires multiple re-keying or reentry of data resulting in potential data entry errors and a documented loss of data integrity and consistency. Additionally, the use of multiple software packages with no established data exchange process makes the system inherently inefficient and prohibitive regarding the exchange of the relevant data required for quality customer relationship management (CRM).

The FrontLine Enterprise System minimizes and/or eliminates the issues of data re-entry and the resulting potential data error and documented loss of data integrity. At a high level, the system integrates the software packages to the degree that it is technically and financially feasible and automates some of the basic CRM functions that are capable of being accomplished with no detriment to the client relationship.

System Specifications

Interface

The basic interface of the FrontLine Enterprise System is web-based and accessible through either Internet Explorer 4.0+ or Netscape 4.0+.

There are three primary sections for interface into the system based on user types: public, client-restricted and company-restricted. There are no sub-user groups in the public section and no UserID/Password requirements. There are sub-user groups within the client-restricted and company-restricted sections and UserID/Password requirements.

Each section has a unique URL for access within the flsafety.com domain. The public section is the flsafety.com URL. The client-restricted section is a subfolder based on the client name (i.e. flsafety.com/cbl for CBL Properties). The company-restricted area is through the flsafety.com/admin URL.

| | | Sub- | |
|---|---|---|---|
| | | User | UserID/Pass |
| Section | URL | Groups | Protect |
| Public | flsafety.com | No | No |
| Client- | Based on client name (i.e. | Yes | Yes |
| Restricted | flsafety.com/cbl) | | |
| Company- | flsafety.com/admin | Yes | Yes |
| Restricted | | | |

The Client-Restricted sub-user groups are Program Coordinator, MD and Staff. Program Director has full privileges within the client-side interface. MD has READ ONLY privileges to the full client side interface. Staff has READ/WRITE privileges to the “Programs” section within the client-side interface.

Security

Data security is provided via UserID/Password combination. Data integrity is maintained via regularly scheduled backups of the system and database to DAT and/or CD-ROM per the site host's service offerings.

Platform

The platform of the FrontLine Enterprise System is open for discussion. FrontLine currently maintains no web servers and as such has no prerequisites beyond having a solution that is web-enabled. Windows NT is preferred for ease of maintenance. The company operates on the Windows platform.

FrontLine has several software tools already in place. The enterprise system minimizes and/or alleviates the need for some or all of these tools:

| Software | Version | Use |
|---|---|---|
| Act! | 2001 | Contact Management |
| PeachTree 2002 | 9.0 | Accounting and Inventory Management |
| Excel | 2000 | Reports and General Data Management |
| FedEx Shipping | ? | Shipping of Equipment (non-exclusive) |
| Software | | |
| Less Stress | ? | Course/Instructor Info and Certification |
| (FileMaker) | | Data Management |

Public Section

Kricos has been selected to provide ONLY the Public Section redesign for the FrontLine web site.

Overview

The Public Section of the FrontLine Enterprise System is the publicly available web site. This is generally the first face of the company viewed by anyone. The audience includes clients, potential clients, distributors, manufacturer sales representatives, investors, potential investors, employees, potential employees, partners, potential partners and competitors. As such, the Public Section is informative and indicates strategic direction through vision, but does not provide strategic data (i.e. pricing, extensive client lists, etc.) or represent significant programming assets.

Existing Public Section Review

The existing Public section is informative and entertaining. The design is relatively simple and easy to navigate. It provides the appropriate level of information required for its intended audiences. The functions described in the Client-Restricted and Company-Restricted sections that should be accessible via the Public site are already in place.

Some minor issues requiring minimal expense should be addressed.

Some links are broken or non-functional (i.e. About Us, News and the Members Only Discussion Board all return a 404 error).

The FrontLine logo on http://www.flsafety.com/faq1.html is disproportioned in both Netscape and Internet Explorer.

Spelling errors in the “Heart Saver Quiz” should be corrected (i.e. “responsive” in a question and “about 10as” in an answer) and the correct answer should be displayed when an incorrect answer is given.

Suggested improvements to the site:

The Training/Services/Equipment menu on the Home Page should be available on all pages as the standard menu is. This may entail a change to the presentation of the Training/Services/Equipment menu.

Redundant navigation should be added (i.e. the logo should link back to the home page).

The “Heart Saver Quiz” should be more prominent via a direct link from the main menu page.

The end of the “Heart Saver Quiz” should include the main menu links or at a minimum a link back to the flsafety.com home page.

Client-Restricted Section

Overview

The Client-Restricted Section is for clients to view and maintain their FrontLine-related data. Once the user logs in, they are presented with a page specifically for the client. The page bears the company's name and some basic information on the company. Additionally, a FrontLine-related news story is displayed.

A limited number of demo accounts are required. Those accounts are for use by the FrontLine Account Management Team in association with their sales efforts. These accounts should be identified and should not feed information into the reporting or other features of the database. As such the demo may be a copy of the functioning FLES operating on a dummy database.

The FrontLine Enterprise System will be made available to consumers of competing equipment such as the LifePak 500 from Medtronics Physio-Control, the Survivalink AED and numerous emergency oxygen options. The system allows for information that is unique to each product. The system also allows the parameters to be set for frequency of regularly scheduled e-mails and automated e-mail reminders based on manufacturer recommendations.

The client to locations relationship is a 1-to-many relationship. Many, if not all clients require a separate login for each location since the program manager is often unique to each location.

The location to installed units relationship is a 1-to-many relationship. There may be multiple units with varying types of equipment and varying supplies with differing expiration dates and lot numbers associated with each unit.

Main Client Menu

The Main Client Menu provides the user with the following options:

Action Items

Program

Order

Training

Equipment

Team

MD

Preferences

Version 2.0 Feature: Action Items

The Action Items is a client side view of the Action Items function as described in the company-Side Interface. Items are specific to the client and prompt for service needs in advance.

Program

The Program section is for the client entry and access of logged AED usage, Oxygen usage and Life Safety Program Checklist data.

[image]

Diagram #1: Interface Sketch of Client-Restricted Section>Program

This section has the following sub-sections:

File a Report

AED and Oxygen Daily Status Report (Product Specific)

Life Safety Program Checklist

AED Use Report

AED Post Use Instructions (Product Specific) (Read Only)

AED Return to Service Report (Product Specific)

Oxygen Use Report

Oxygen Post Use Instructions (Read Only)

Oxygen Return to Service Report

View Reports

Print Report

Export Report

File a Report entails completing and submitting an AED and Oxygen Daily status Report (See Appendix E for a sample document), Life-Safety Program Checklist (See Appendix F for a sample document), AED Use Report (See Appendix G for a sample document), AED Post Use Instructions (See Appendix H for a sample document), AED Return to Service Report (See Appendix I for a sample document), Oxygen Use Report (See Appendix K for a sample document) or Oxygen Return to Service Report (See Appendix K for a sample document). Once the user has completed a report, they are prompted to review the data and confirm it before posting it and reminded that they will not be able to alter the data once it is posted without assistance from FrontLine. The confirmed data is recorded and date/time stamped with the real time of posting. It is then available for review by the client using the View Reports function. The AED Post Use Instructions and Oxygen Post Use Instructions are read only documents for information purposes.

Note that AED and Oxygen Return to Service Reports must be directly associated respectively with an AED or Oxygen Use Form unless the user identifies the unit as “Removed for Equipment Service” when posting the “Return to Service” form.

All data is subject to an integrity check and a check to determine if values fall within safe equipment operational ranges. If the ranges are not satisfactory the system prompts the user to review the data for accuracy. If the data continues to be outside of the acceptable ranges, an action item is queued (see Action Items within the Company-Side Interface).

Version 1.1 Feature: HeartStream and Survivalink AED models come with data cards to capture information during a usage. Medtronics Physio-Controt units (LifePak) come with a modem uplink. These reports are event specific. FrontLine reads this data as a service to their clients and appends it to the Usage Report filed in the Enterprise System. Frontline maintains this data on behalf of its clients under HIIPA guidelines for third party maintainers of personal medical data.

View Reports provides a chronological listing of reports for the client. By selecting a report, the user may view the report.

Version 1.1 Feature: The user may filter or sort the listing of reports by date, AED, and Oxygen by clicking on the header identifying the column.

Print a Report allows the user to print a copy of the report. A user must first select a report using the View Reports function prior to utilizing the Print a Report function.

Export a Report allows the user to export the report data to an Excel file format or an ASCII file format. A user must first select a report using the View Reports function prior to utilizing the Export a Report function.

Clients are not permitted to delete or alter logged reports. Only FrontLine staff is able to alter reports at the client's request.

There are numerous products that compete with the core equipment offered and maintained by FrontLine. Since FrontLine will offer its Enterprise System as a service to customers using competing products, it is necessary to accommodate those products and their variations relative to the FrontLine product line.

Use Report, Post Use Instructions, Return to Service Report and Life Safety Program Checklist (FrontLine terminology for manufacturer's recommended maintenance schedules), vary by product. The system allows the system user to select the appropriate Manufacturer/Model combination from a list of products accommodated by the system from a dropdown list. The system then applies the corresponding appropriate documentation. This parameter can be set only in the FrontLine staff interface.

Order Products

Order Products is an online shopping cart of products available through FrontLine. Clients may search for products by hierarchical category (to be provided) or by keyword. Larger clients purchase using a purchase order. This circumvents the need for credit card processing.

Version 1.1 Feature: The shopping cart is enabled for major credit card processing.

Orders are logged and queued to their FrontLine representative as described in the Company-Restricted Section of the system. Once an order is shipped, a customer service representative notes the shipment and the system automatically sends an e-mail to the client.

Note: The FedEx shipping software may be an issue for import/export reasons. FedEx is not used exclusively.

Training

The Training section is for client access to scheduled training sessions and provides an interface through which the client may request that training services be scheduled. If no course is scheduled, the system automatically generates a suggested time frame for the next course and offers the client the option to request a scheduling of courses. The time frame is a parameter set by FrontLine in the Company-Restricted section of the system.

[image]

Diagram #2: Interface Sketch of Client-Restricted Section>Training

This section has the following sub-sections:

View Schedule (auto displayed on clicking into Training section)

Request Training

Clients request a training course via a form page (to be provided) listing the services offered with check boxes for the client to indicate their areas of need. The request may also be made via phone call or e-mail, in which case, the course is set up in the Company-Restricted section. The system queues the request as an Action Item and prompts the appropriate FrontLine representative to process the request.

Equipment

The Equipment section is for client access to equipment inventory records and provides an interface through which the client may update their equipment inventory information. Through the Equipment interface, the client is able to view a log of their equipment and update any changes to the equipment. Additionally, the client is able to print the Equipment Log or export it as an Excel file.

[image]

Diagram #3: Interface Sketch of Client-Restricted Section>Equipment

The Equipment section offers the following functions in addition to viewing records:

View Equipment (auto displayed on clicking into Equipment section)

Update/Edit

Print

Export

A change to the Equipment data updates the client records and logs the changes. The logged information is accumulated and sent periodically to the client as a confirmation. Also, the system queues the information to the appropriate customer service representative for follow up if required.

Team

Through the Team interface, the client is able to view a log of their certified team members, view each member's certification information including class type(s) and certification date(s), note changes to a member's status (i.e. Active or Inactive) and modify the Life Safety Cabinet(s) to which that member is assigned (in instances where >1 cabinet is located in a facility). Additionally, the client is able to export the report as an Excel file.

[image]

Diagram #4: Interface Sketch of Client-Restricted Section>Team

A change to a member record updates the client records and logs the changes. The logged information is accumulated and sent periodically to the client as a confirmation. Also, the system queues the information to the appropriate customer service representative for follow up if required.

Medical Director (MD)

The Medical Director section is for the maintenance of Medical Director, Prescribing Physician, Local EMS (Information currently collected and maintained in form exhibited in Appendix L) and Good Samaritan Legislation information. All data is displayed by clicking on the MD tab. By selecting the edit option, the user may update select portions of the records highlighted in gray in the screen below.

[image]

Diagram # 5: Interface Sketch of Client-Restricted Section>MD

Additionally, the client is able to print the Medical Director record or export it as an Excel file.

Edit

Print

Export

A change to the Medical Director record updates the client records and logs the changes. The logged information is accumulated and sent periodically to the client as a confirmation. Also, the system queues the information to the appropriate Account Manager for follow up as required.

Preferences

Within Preferences, the user may determine certain parameters for their account.

[image]

Diagram #6: Interface Sketch of Client-Restricted Section>Preferences

The available options are:

Name

E-Mail

Receive Newsletter

Receive Confirmation of Account Changes

Password

Medical Director's Password

Staffs Password

Client-Oriented Automated Functionality

A certain degree of client-oriented activity from FrontLine out to the client takes place as an automated function behind the scenes in the form of chron jobs and automatic replies. FrontLine's core products, the FR1E and FR2, have varying manufacturer's scheduled maintenance recommendations, as do competing products such as Survivalink and LifePak 500. Standard parameters are maintained according to manufacturer's guidelines regarding the frequency of prompts for product program support and prompting for equipment maintenance issues.

Outgoing E-Mail

Periodic e-mails are sent to clients. The content of the e-mail ranges from generic information to client-specific information generated based on the data collected and maintained by the client and FrontLine.

Monthly E-Mail

Each Life Safety Program Coordinator (client representative tasked to check equipment and manage training resources) receives e-mail once per month. The time frame can be changed to suit a client's unique schedule. The system default date is set in the system and can be changed for each client to suit the client's particular needs. An override allows a FrontLine representative to disable this function.

The pre-formatted HTML e-mail includes the following information:

Prompt to Update Records in their Client-Restricted Section (via system-generated link).

Lead from the Monthly Article (i.e. a Hero of the Month) with link to remainder of story (same link as previous).

Next Scheduled Training Course or Suggested Time Frame (Calculated by system and based on last course date. Three months prior to suggested date, this function also posts a notification to the account manger.).

Prompt with names of Team members requiring recertification within the next 90 days.

Prompt for new supplies beginning three months prior to the Equipment Expiration Date (Also posts notification to FrontLine account manager's queue). Includes reminder of AED batteries with potentially decreased life span due to usage.

Prompt to go through their Life Safety Program Checklist (to be provided) with a link to the appropriate portion of the client's Program section.

Prompt for questions/comments with FrontLine Company Contact Information.

Good Samaritan law updates based on their location state (this data is actively maintained on www.padl.org).

Version 1.1 Feature: Online video and review test for refreshing of training.

Training Course Prompt

The system polls each client account on a periodic (to be determined) basis to determine the number of certified staff in the client's records. The system polls for certified Team members, their shift and the life safety cabinet for which they are responsible in the event that there is more than one cabinet. Employers will run 1-3 shifts and are required to have a certified staff member available during each active shift to cover the cabinets installed. The employer provides information on the number of shifts that is input into the system by the account manager. If an employer reaches a threshold point (parameter set in Company-Restricted interface) where there are no Team members certified for any given shift, the training course prompt is sent.

For employers with a single shift, if the number of certified staff reaches the “recertification recommended” level (preference set by the account manager, but defaulted to three), then the system e-mails a prompt for training (to be provided) to the client, cc's the account manager, and posts a notice to the account manager's Action Items in the Company-Restricted interface.

Confirmation E-Mail

Periodically, all logged activity on each account is summarized and sent via automated e-mail to the client. This serves as their confirmation of the activity on the account and limits the intrusiveness of multiple confirmations for each individual action. Accounts with no activity receive no e-mail.

The confirmation e-mail data is logged and remains actively accessible within an account for a period of one year. Confirmation e-mail data >365 days is archived.

Automated E-Mail

Select events trigger an automatic e-mail reminder to the Life Safety Program Coordinator. The posting by a user of an AED Use Report or Oxygen Use Report prompts an e-mail directing the user to the Post Use Instructions for their unit(s) and the Return to Service Report for their unit(s).

Order Processing

Once an order has been shipped and confirmed in the FrontLine Enterprise System, confirmation of that shipment is sent via e-mail to the client. The client's file is updated to reflect their purchase.

Version 1.1 Feature: Tracking information (as available) is included in the order confirmation e-mail

Three days after the shipping date, the system sends an automated follow up to the client asking if the order has been received and was shipped properly. The Account Manager is cc'ed and is posted on the automated e-mail as the sender so that any written reply is routed to them.

Version 1.1 Feature: A link included in the e-mail directs the user to a form page where the client may rate their ordering experience

Company-Restricted Section

Overview

The Company-Restricted Section is for establishing and maintaining client-specific information and FrontLine internal data. The information on the page viewable after login is a standard format for all users with the actual data presented custom to the user.

Like the Client-Restricted Section, a demo is provided running on a separate dummy database.

The format includes an Administrative Menu, Action Items and Recent Activity section. The System Administrator establishes new user accounts.

Administrative Menu Features

The Administrative Menu features are visible to all users. Access to the functionality is defaulted to a standard set of functions. The System Administrator has the discretion to change the defaults on an individual account basis to extend or restrict access for an account user. The menu options and standard access defaults are as follows:

| Section | New Account Access Default |
|---|---|
| FrontLine Home | |
| Action Items | |
| Clients | |
| Search | Yes |
| Add Yes | |
| Training | |
| Search Courses | Yes |
| Add Courses | Yes |
| Search Instructor | Yes |
| Add Instructor | No |
| Orders | |
| Search | No |
| Fulfill | No |
| News | |
| Search | Yes |
| Add No | |
| FL Reports | |
| Search/Define | No |
| Print | No |
| Export to Excel | No |
| Admin | |
| Search User | No |
| Add User | No |
| Review Log Files | No |
| View Queue | No |
| Select an Employee | No |
| View Entire Queue | No |
| Export Entire Queue | No |
| Preferences | |
| Change Password | Yes |

FrontLine Home

FrontLine Home is the flsafety.com home page.

Action Items

The Action Item list is the primary content for each FrontLine Company-Restricted site user. It is a list of customer-service related action items prompted by the FrontLine Enterprise System through automated system events and interaction with the system by client, potential clients and FrontLine staff.

[image]

Diagram #7: Interface Sketch of Company-Restricted Section>Action Items

The list is comprised of two types of items—forms and notifications. Forms require an action on the part of the recipient. Notifications require only acknowledgement from the recipient. A user may opt to reassign a queued task to another FrontLine employee. They may do so by choosing the employee from a dropdown list provided next to the queued item.

Clicking on a queued item automatically directs the primary browser to display the main client account information interface and simultaneously opens the Action Item Prompt Window containing the queued task. The user supplies the required data in the Action Item Prompt Window to move the queued item to inactive status. Alternatively, the user does not provide the data leaving the Action Item active and still in the viewable queue. Alternatively the user may opt to reassign the queued task to another FrontLine employee or to as many as two employees. They may do so by choosing the employee(s) from a dropdown list provided at the bottom of the Action Item Prompt Window. A notes section (one for each employee to whom the task is reassigned) is provided so that the original recipient can direct the follow-on activities of the employees to whom the Action Item is redirected.

Each queued item has an origination date/time stamp. If reassigned, a reassigned date/time stamp is assigned. The default presentation order is based first on priority level (defined in the charts below) and second on origination date with 1 being highest priority.

Version 1.1 Feature: Users may sort their queued items by date, priority or client by clicking on the heading of the column.

Users may also choose to view active or inactive queued items. The system administrator has the option to view to View All Action Items resulting in a listing of all queued items in the system. The system archives the queue data periodically and purges inactive items over 365 days old periodically. Active items are maintained until made inactive. The system administrator also has the option to Export the Entire Queue to Excel for analysis of data.

The following Table of Action Items details the information maintained in the Action Items Section:

| | Primary | | |
|---|---|---|---|
| Action Item Type | Recipient | CC'ed to | Priority |
| AED Battery Low | Acct. Mgr. | T&S Coord. | 1 |
| Oxygen Low | Acct. Mgr. | T&S Coord. | 2 |
| AED Return to Service | Acct. Mgr. | T&S Coord. | 3 |
| Report Not Filed | | | |
| Oxygen Return to | Acct. Mgr. | T&S Coord. | 4 |
| Service Report Not Filed | | | |
| AED Equipment Usage- | Acct. Mgr. | T&S Coord., VP | 5 |
| Acknowledge Report | | Sales, MD, CEO | |
| AED Equipment Usage- | Acct. Mgr. | VP Sales, MD, | 6 |
| Call Client, Check | | CEO | |
| supplies needs. | | | |
| AED Equipment Usage- | Acct. Mgr. | na | 7 |
| Call MD | | | |
| Oxygen Equipment | Acct. Mgr. | T&S Coord., VP | 8 |
| Usage-Acknowledge | | Sales, MD, CEO | |
| Report | | | |
| Oxygen Equipment | Acct. Mgr. | na | 9 |
| Usage-Call Client, | | | |
| Check supplies needs. | | | |
| Oxygen Equipment | Acct. Mgr. | na | 10 |
| Usage-Call MD | | | |
| Life Safety Program | Acct. Mgr. | T&S Coord. | 11 |
| Checklist Not Filled Out | | | |
| According to Schedule | | | |
| Training Request | T&S Coord. | Acct. Mgr. | 12 |
| (Existing Client) | | | |
| Order | Account | Product Coord. | 13 |
| | Manager | | |
| Version 1.1 Training | | | 14 |
| Request | | | |
| Information Request | New Accounts | VP Sales | 15 |
| Order Not Shipped- | Acct. Mgr. | VP Sales | 16 |
| Aged 5+ days | | | |
| Order Shipped | Acct. Mgr. | Client | 17 |
| Instructor | T&S Coord. | na | 18 |
| Recertification Due | | | |
| Change of Course | Acct. Mgr. | T&S Coord., | 19 |
| Information | | Instructor | |
| Change of Account | Acct. Mgr. | na | 20 |
| Information-Check | | | |
| data. Call Client as | | | |
| required. | | | |
| Change of Employee | Acct. Mgr. | na | 21 |
| Status-Call to Client | | | |

AED Battery Low

The system checks Daily Status Reports, Monthly Program Checklists and AED Post Use forms for data integrity. In the event that data input indicates a marginally or non-functioning unit, the user is prompted via a pop-up box to confirm the data and take appropriate steps to address the deficiency as it exists by placing an order and/or updating equipment records. If the data is confirmed accurate, an IMMEDIATE notification is generated in the Action Items system. The system continues to check the data when running its usual chron job and generates additional daily warnings as appropriate.

Oxygen Low

Identical to the “AED Battery Low” notification as applies to oxygen.

AED Post Use Status

Following an AED use, a client must follow the Post Use Instructions Form and complete the AED Return to Service Form within 24 hours. A chron job checks to see that an AED Use Form has an associated AED Return to Service Form posted within 24 hours of the posting of the AED Use Form. If the AED Return to Service Form is posted, the notification reflects that fact. If not, the system continues to send a notification once daily until the AED Return to Service Form is completed. The notification includes the option for the Action Item recipient to send an automated e-mail to the registered Program Coordinator for the client prompting them to complete the appropriate form. This effectively eliminates that instance of notification, however subsequent daily notifications are initiated and appear as Action Items in the event that the form continues not to be completed.

Oxygen Post Use Status

Functions for Oxygen identically as above for “AED Post Use Status.”

Equipment Usage Notifications

An equipment usage report prompts the account manager to acknowledge the report and provides a prompt of task(s) which the account manager must acknowledge including:

AED Equipment Usage—Acknowledge Report (Includes copy of report). Ask if supplies, support, or services are needed (Includes list of client's product inventory).

AED Equipment Usage—Client Called (Includes client phone number)

AED Equipment Usage—Call MD (Includes phone number of Medical Director)

Oxygen Equipment Usage—Acknowledge Report (Includes copy of report). Ask if supplies, support, or services are needed (Includes list of client's product inventory).

Oxygen Equipment Usage—Client Called (Includes client phone number)

Oxygen Equipment Usage—Call MD (Includes phone number of Medical Director)

Life Safety Program Checklist Not Filled Out According to Schedule

The Life Safety Program Checklist is filled out monthly and posted. If it is not posted within 32 days of the most current Checklist (note need for exception in programming on first instance), a notification of that fact is made.

AED and TxO2 Daily Status Report Not Filled Out

The daily reporting function is enabled/disabled in client preferences. The user can set their preference on how long the report may go unfilled in terms of days before being notified via e-mail of the deficiency. If a Daily Status Report goes 7 (seven) days or longer, a notification is initiated in the Action Items.

Version 1.1 Feature: The client-side notification may be directed to an alphanumeric beeper, PDA, automated telephone system or other communications device(s).

Training Request (Existing and Potential Client)

A client or potential client initiates a training request through a form page. The FrontLine primary recipient receives the information as a pre-filled form page. The form page is identical to the one used for scheduling a new course in the Courses in the Company-Restricted section.

Version 1.1 Feature: In the event of a potential client request, the information also includes account information in order to initialize a new account during the entry process in addition to the training details request.

The FrontLine representative is required to process the information, finalize the details (time, availability, number of employees, etc.) and confirm the data before it is posted to the system as an actual training course. The data undergoes an integrity check prior to posting in the database. On posting to the database, a confirmation e-mail of the details of the training course is sent to the client's e-mail as registered with FrontLine.

A user may opt to cancel a Training Request if the request is not or cannot be fulfilled.

Information Request

An information request comes from the Public section, the Client-Restricted section or may be taken as an incoming phone call. The information is processed into a page for viewing and assigned to the staff member responsible for new accounts manager. The staff member is responsible for verifying sufficient data from the request in order to establish a new client account and for responding to the request or assigning the task to another party.

Instructor Recertification Due

A chron job periodically reviews each instructor's recertification dates. As recertification dates for an instructor approach, the Training & Support Coordinator receives a 90-60-30 then ongoing weekly reminder. If an Instructor does not have a certain given certification, the system does not prompt the Training & Support Coordinator for a recertification.

Change of Course Information

The change of course information notes changes to the course at the top of the notification and restates the course details in full.

Change of Account Information

The change of account information notes changes to the account at the top of the notification and prompts the account manager.

Call Client if data appears to require a call.

Check for data integrity.

Change of Team Member Status

The change of Team Member status notes changes to an Team Member's status by an employer.

Clients

Within Clients, a user is able to search or add a client account. The search function is used as a gateway into the account and the ability to perform functions within a client's account.

Search

A user searches using any identifying information for the account including Account ID, Company Name, Address, City, State, Zip, Phone, E-Mail, Contact Name, etc. The interface for the search allows the user to enter search criteria into the appropriate field. The search returns entries matching the input search criteria. From the list, the user may access the main account interface by selecting the client. If a client has more than one property or represents multiple clients, a sub list of those selections is presented from which the user selects.

Programming Note: The client to location relationship is a 1-to-many relationship as stated previously. Some accounts will have a parent account that has access to each of the child accounts, but unique users maintain the child accounts.

Once a user selects a specific client (or client location), the screen format remains basically the same. The data presented is varies slightly.

The Administrative Menu remains unchanged.

The Action Items is replaced by an interface identical to the tabbed client interface, but with an additional Contact Information tab. The tabbed pages are as follows and the data contained on each page is detailed in forms and the accompanying data model:

Contact Info (includes Authorized UserID/Password Maintenance)

Program

Order

Training

Equipment

Team

Medical Director

Preferences

The Recent Events section shifts to reflect recent event as they relate the specific client.

Add

To add a new account, the user provides a suitable Account ID—properly formatted and not duplicated for another account. The FrontLine Enterprise System uses this Account ID to establish a new sub directory name that will be used to establish the URL for access to the Client-Restricted Section. Entries are checked for validity as a directory name and for duplication against any other existing directory. For example, CBL Properties can be assigned the Account ID “cbl,” but not “cbl prop” since a directory name cannot contain a space.

After supplying a valid Account ID, the user is prompted for required data for a new account.

Users may edit any account data, except the Account ID. For reasons of data integrity, only the System Administrator may alter the Account ID.

A client account cannot be deleted. It may be made inactive, but all data is retained.

Training

Within Training, a user is able to search or add training course and instructor information. The search function is used as a gateway into the training record and the ability to alter training record data.

Search Courses

A user may search for an existing course by Date, or a keyword search on the Class Type, Location, Contact Name, Company, or Instructor fields or for an Instructor using the Instructor Name. An interface allows the user to input search criteria into the appropriate search fields.

The search function is the gateway to the editing function. Once a course is identified, the user selects it and the information is presented in a read-only format. This format is suitable for printing. The user must then select the option to edit the course information and the course information is presented as a pre-filled and editable form page.

Add Courses

Within Add Course, the user sets up new courses by providing the training course specific data (See Appendix R for a sample document). The user must select an existing client account via a valid Account ID from a dropdown box (Java interface preferred). Failing a valid Account ID, the user must go to the Add Client interface, select a different account or abort the training course entry. In the event that the course is taught in a public setting where there is no specified employer, an organizational account may be used (i.e. American Heart Association) or a Not Applicable account. The system prompts the user to supply the following information:

Data on class attendees is also maintained through this interface. The data may be entered when the course is set up; after the course is set up, but before it is taught; or after the course is taught depending on the client contact's level of preparedness. The interface allows the flexibility to enter the data at any time and compensates for the potential falsification of records by time/date stamping each class attendee record entry.

New attendees are defaulted to “Active” status with the employer and the client is the default employer. Since some classes are taught in a public setting, it is necessary to override the client default to an organizational entity or not applicable.

By adding a new course, the user generates an invoice and is prompted to provide a cost for the training service in order to close the task from their Action Items list (they may reassign this final task back to the Account Manager). The invoice is posted in the FrontLine Enterprise System 30 days prior to the scheduled training date, or immediately if the training date is less than 30 days out. In either case, the due date for the invoice is the scheduled training date. The training invoice information is queued in the order system (described in detail on page 18 in the Action Items/Order section) and exported to Peachtree for billing with the other orders.

Instructor

Within Instructor, a user is able to search or add an Instructor and their associated training credentials information. The search function is used as a gateway into the Instructor record and the ability to alter Instructor record data.

Search Instructor

A user may search for an Instructor by Name, Address, City, State, Zip, Certification Number and/or Expiration Date of Certification. An interface allows the user to input search criteria into the appropriate search fields.

The search function is the gateway to the editing function. Once an Instructor is identified, the user selects it and the information is presented in a read-only format. This format is suitable for printing. The user must then select the option to edit the Instructor information and the Instructor information is presented as a pre-filled and editable form page.

Add Instructor

Within Add Instructor, the user sets up new Instructors by providing the required data.

Orders

A client initiates an equipment order through the online catalog or a FrontLine representative may enter an order for a client via their access to the account (See Appendix W for an inventory list).

Version 1.1 Feature: The FL Quote system acts as a front end into the Enterprise System. Account Managers prepare quotes within the system. That information is maintained as a potential sale and provided with a unique tracking number. If a quote is converted to a sale, the Account Manager selects the quote and qualifies it into the system as an active sale for fulfillment. Notification is provided to the Training and Product Coordinators as appropriate.

Orders are assigned a Sales Order number (serialized), which ultimately becomes the invoice number once the order is filled. The orders initially come into the Account Manager so that they are informed, but are quickly passed along to the Product Coordinator for fulfillment. An Account Manager or the Product Coordinator may cancel an order resulting in a notification to the Account Manager. The Order interface as an Action Item varies significantly from the interface for the client. In order to satisfy the required actions, information about each product must be entered. That information is:

Lot # and/or Serial # of the Product

Expiration Date of the Product (as applicable)

Medical Director by Serial Number of the AED

Orders commonly specify a quantity of >1 of any given item. The required data must be filled out for each unit (i.e. a request for 3 oxygen masks requires that the Lot # and Expiration Date be entered for all three masks individually).

Not all items are actively maintained in stock. As such, the system is flexible enough to allow partial shipments of an order. Partial shipments are indicated by filling in the required data on the available items and then selecting the backordered checkbox for the unavailable items. The partial shipment is given a serialized 3-digit suffix (i.e. −001) to indicate that it is a partial shipment. The remainder of the shipment remains active in the Action Items queue. As that ordered is fulfilled, it is given additional serialized 3-digit suffixes for each shipment.

With each serialized shipment, the FrontLine company representative must also specify the shipping charges for each order and that information is provided to the client. Sales taxes are not applied to shipments with destinations outside of the state of Tennessee. Orders within Tennessee should indicate that Tennessee State Sales Tax is applied as required.

Notification of the shipment of an order is sent to the Action Items queue. Orders outstanding for more than five (>5) business days also generate a notification to the Action Items queue for the Account Manager to follow up as required.

Orders are logged by the system. Those orders are then output in a standard format to Excel for manual import into the FrontLine accounting solution (Peachtree). The system provides feedback to the user regarding the last date an export was performed and a log of dates on which an export was performed. Users can set parameters for the export including date rang, invoice range and/or client range. The file format is a .csv file with the following data.

| | |
|---|---|
| Account ID | 8 Character ID code |
| Date | MM/DD/YYYY |
| Invoice # | |
| Description | 20 |
| Amount | (Sales are negative) |
| Tax Code | 1 is taxable, 2 non-taxable |
| Line Items | # of Line Items in Order (Note changes |
| | due to partial shipments) |
| GL Sales Acct. | GL Account to which the Sale is debited. |
| GL Revenue | GL Account to which the Revenue is |
| | credited. |
| Due Date | Required for Training only. Otherwise |
| | according to defaults in Peachtree. |

As new clients are added, account ID, company name, contact information, shipping information, etc. are required by Peachtree for invoicing. A similar export function for client account data provides this data to Peachtree via an import in advance of the invoicing import.

News

Within the News section, users view newsworthy events relating to FrontLine. News content consists of three types—public, private and product specific. Public content is generic content suitable for all FrontLine clients and staff. Private is suitable for FrontLine internal consumption only. Product Specific content is specific to clients based on their mix of products.

An author selects from Public/Private/Product Specific. If they select Product Specific, they are further prompted with a series of check boxes listing the various types of equipment supported by FrontLine. An author may select a specific sub-group of equipment users and direct that content only to clients with that equipment (i.e. in the event of product recalls, special notices or other product-specific information).

Search

Users search news items via keyword or date of the article.

Add

Authorized users add articles at their discretion. News articles have several fields all of which are required:

Date to Post

Date to Inactivate (Do not allow >1 month)

Headline

Lead

Body Text

Author's Name

Public/Private/Product Specific

Priority

FL Reports

Within the Reports section, users access and define parameters for pre-defined reports. The user may view the report on screen, print it or export it to a predefined Excel spreadsheet. Among the reports are:

| | | Sample |
|---|---|---|
| Report Type | Description | Documentation |
| *Contact Report | Client Contact | Appendix M |
| | Information | |
| *Agilent HTST Market | Tracking Report to | Appendix N |
| Tracking Report | Agilent on AEDs | |
| *Agilent HSG Market | Tracking Report to | Appendix O |
| Tracking Report | Agilent on AEDs | |
| *FrontLine Product Tracking | Product Placement | Appendix P |
| Worksheet | Documentation | |
| *FrontLine Product Tracking | Internal | Appendix Q |
| Order Worksheet | Goods/Services | |
| | Notification | |
| *FrontLine Course Roster | Hand-completed POS | Appendix S |
| | data-entry form. | |
| *Life Safety Program | Listing of FrontLine | Appendix T |
| Tracking | Programs | |
| *FrontLine Client Training | Client Employees | Appendix U |
| Status | Trained and Status | |
| *American Heart Association | Tracking Report for | Appendix V |
| Tracking Report | Training to AHA | |
| Version 1.1 Feature: Client | Export to Print the | TBD |
| Record Report | Entire Client History | |
| Inventory Forecasting Report | Inventory Forecast | See Description |
| (detail below) | Based on Exp. Date | Below. |

*A copy of the format for each of these reports is provided in the Appendix.

Inventory Forecasting Report

The system maintains data on expiration dates for each piece of equipment and accessories. A chron job runs against that data on a daily basis to forecast inventory needs. The system provides a list of products by polling its database. Much like an accounting package displays 30-60-90 day account status, the system provides a 30-60-90 day inventory prediction based on the expiration date of equipment still in place.

| | 30 | 60 | 90 | Total Next 90 |
|---|---|---|---|---|
| Equipment | Days | Days | Days | Days |
| FR1E | 2 (10) | 6 (15) | 19 (23) | 27 (48) |
| Batteries | | | | |
| FR1E AED | 1 (12) | 5 (13) | 15 (21) | 21 (46) |
| Pads | | | | |

The display presents two sets of numbers, one of which is in parenthesis. Since each product may be shipped with a backup supply, the chron job makes allowances for the presence of more than one unit. The first number is the number of units required to ensure that all clients have at least one of the product on hand. The number in parenthesis is the amount of inventory required in order to ensure that all clients have both a primary and backup product.

Ideally, if properly managed by the consumer and if Account Managers follow system prompts for each account, the number of 30- and 60-day needs should be minimal.

By clicking on any forecasted inventory number, the user is able to obtain a list of the clients with a need for each product.

| | | Expiration |
|---|---|---|
| Client Name | Product | Date |
| ABC Corp. | FR1E Battery | Oct. 01, 2001 |
| XYZ Corp. | FR1E Battery | Oct. 01, 2001 |

By clicking on any company name, the user is directed to the client's inventory management information (the Equipment tab within the client's Enterprise System records).

Admin

Within the Admin section, users are able to manage company staff access and system logs. Access to this functionality is generally restricted to the System Administrator.

Search User

A user searches user accounts via any required data fields—UserID, Name, or E-Mail (a full list of data fields for an account follows in the Add User section). An interface allows the user to input search criteria into the appropriate search fields. The Search function is the gateway for editing a User's account and access privileges.

The System Administrator may edit any data for the account including the User ID though such an action should take place only under extenuated circumstances.

The system does not display a user's password. The System Administrator may reset the user's password by entering a new password and confirming that password.

Company staff accounts are never deleted, but are inactivated. In the event that a company staff account is inactivated, the system prompts the System Administrator for a new staff user account to which automated system functions for the inactivated user are rerouted.

Add User

The System Administrator sets up new account by providing a unique User ID and required information on the user. The required information is designated via an asterix (*):

User ID*

Password*

Name*

E-Mail*

Active/Inactive (defaulted to Active)

Phone (Work)

Cell Phone

Review Log Files

Log files on changes to Client information and staff information are logged for security purposes. The system logs each attempted log-in. Login attempts are purged once they age 180 days. Login Logs may be sorted by Date/Time, UserID or IP Number.

Log-In Log

Log-in

UserID

IP Number

The system logs any account changes. Account change information is purged once it ages 30 days. Account Changes may be sorted by Date/Time, Account ID, User ID, or IP Number.

Account Changes Log

Date/Time

Account ID

Data Field

Previous Data

New Data

UserID for Change

IP Number for Change

View Entire Action Item Queue

The View Entire Action Item Queue function displays all active Action Items in the system. Inactive action items may be viewed by selecting the option to display them. The user may sort via Date or Priority, but standard default is Priority first, Date second. Viewing the entire Action Item queue allows the user to access any queued item with the privileges of the primary recipient of the queued item.

Preferences

Users may set only one preference—their Password. Password changes require double entry for data integrity.

Company-Side View of the Client Interface

The Company-Side view of the client interface is identical to the client interface with varying degrees of access to data and data correction tools (See Diagram #8 for an interface sketch). These variations are detailed below:

Contact

The Contact tab appears only on the company side of the interface. It contains client contact information as found in tblClient and tblClientSub (reference data model) and notes regarding the client contact history. Also displayed is information on local training centers and their contact information (Information currently collected and maintained in form exhibited in Appendix L).

Program

The Company-Side view of the Program section is identical to the Client-Side view. The only exception is that there is an option to Edit a report in the Company-Side view. The Client-Side interface does not allow a report to be edited once it has been filed.

Order

The Company-Side view of the Order section is identical to the Client-Side view. This allows phoned, e-mailed and faxed requests to be entered into the FrontLine Enterprise System ensuring their inclusion in the established process.

Training

The Company-Side view of the Training section is identical to the Client-Side view. The only variation is the ability to edit fields in the Company-Side that are not editable on the Client-Side. Those fields are:

Instructor

Scheduled Training Date

Etc.

Equipment

The Company-Side view of the Equipment section is identical to the Client-Side view. All fields editable by the client are editable by company representatives.

Team

The Company-Side view of the Team section is identical to the Client-Side view. The only variation is the ability to edit fields in the Company-Side that are not editable on the Client-Side. In the Client-Side view, a user may change only the status (Active/Inactive), Shift (1, 2, or 3) or Installation (Cabinet location) to which the Team member is assigned. In the Company-Side, all fields may be edited.

MD

The Company-Side view of the MD section is identical to the Client-Side view. All fields editable by the client are editable by company representatives.

Preferences

The Company-Side view of the Preferences section is identical to the Client-Side view. All fields editable by the client are editable by company representatives.

[image]

Diagram #8: Interface Sketch of Company-Side View of the Client Interface>Equipment Activity Log

The Activity Log section highlights significant events as posted in the News section and automatic event notification such as automated outgoing e-mails. Automatic events are posted for a period of six business days.

Version 2.0 Considerations

Future considerations for the FrontLine Enterprise System address issues of scalability and increased functionality.

Scalability

It is anticipated that the FrontLine Enterprise System offers a superior level of service to any available currently in the industry. As such, FrontLine will leverage the system's value by offering it to clients of its competitors (i.e. companies who have purchased hardware and/or training services from a competitor and have ongoing service needs).

The FrontLine Enterprise System is also a key strategic element for FrontLine in the franchising or partnering of its business. The system helps to establish and maintain an ongoing quality of service and consistency between business locations as well as a central data repository. Each office may maintain a core staff including an Account Manager and Lead Trainer at a minimum. The satellite office may depend on a centralized office (either regional or national) for fulfillment of products and services. Training coordination may be on a regional or national basis. Product coordination may be on a regional or national basis. Accounting may be on a regional or national basis. As such, the system allows for information on Training Coordinators, Account Managers, Accounting, etc. to be set as parameters for each franchise location.

Alternatively, it offers a product which competitors may license providing a healthy revenue stream for FrontLine and an industry standard for the collection, maintenance and storage of Life-Safety services in the industry.

The FrontLine Enterprise System will be built as an ASP product. The ASP product should offer the flexibility of easy integration of data from various user sources. For example, if two companies using the FrontLine Enterprise System merge interests, the combining of the databases should be relatively seamless. This may require that the system assign unique identifiers for each set of client records.

Interface

Version 2.0 calls for the extension of the Action Items Interface viewable in the Company-Restricted view to the Client-Restricted view. Clients will be provided a series of actionable tasks to guide them in using the system.

Increased Functionality

Requests for increased functionality are anticipated. Those requests will be prioritized and specified under separate technical specifications documents. Some anticipated requests are as follows:

Capture of contract information (i.e. purchase or lease, initial invoice including equipment, itemized pricing, etc.)

Additional Queue Information (i.e. Additional Forms/Notification Types)

Integration with Shipping System(s) (i.e. FedEx, UPS, USPS, etc.)

Integration with Accounting/Inventory Solution(s).

Elimination of Act! and incorporation of major Act! functionality into the FrontLine Enterprise System. Of note, synchronization of remote account data with centralized data warehouse.

Extension of Online Catalog to include AED, Oxygen, and cabinets not included in Version 1.0 e-commerce capabilities.

Version 1.1

Overview

These specifications are for version 1.1 of the Premedics Enterprise System (referred to as FrontLine Enterprise System in previous documentation).

This is not a complete specification of the version 1.1 system, but a documentation of the version 1.1 enhancements to the initial specification and/or clarifications of functions specified in the version 1.0 documentation.

General

Disclaimer

Provide a standard disclaimer at the foot of each page specifying something to the following effect:

“Implementation of this software package does not replace the need for proper program administration. Situations may occur which are outside of the scope of the software. If such an event occurs, please notify Premedics so that the situation can be evaluated and included in future versions.”

Proprietary Software Licensing Agreement

For each first time log in by a client, they are presented with a software licensing agreement. In order to access the system for the first time, they are required to agree to the terms and conditions of the agreement. Failure to do so results in denial of access to the system.

Agreement with the terms captures the Date/Time of agreement and the user's IP address. This data is stored in association with the User's record. This data may need to be a table since a user may not agree initially, but ultimately decides to do so. In such and event, the system captures the activity regarding the account.

Client Side

Client Side>Team

Multiple Course Types

Team functionality will be extended to accommodate multiple course types divided by category (i.e. AHA, ASHI, Red Cross, etc.). This feature is more readily apparent and more completely described in the Company Side view of the Training section enhancements for version 1.1.

Company Side

Company Side>Client View>Equipment

Launch Date

A required field captures the program launch date. For back entry of programs already in existence, this is a feature that allows for a better management of the program information.

Company Side>Client View>Preferences

Preferences

This section is a data entry clarification for enhancements specified in the Training section of this document.

Course Categories (i.e. AHA, ASHI, Red Cross, Manufacturer, etc.) from which a client may choose are designated within the client's preferences on the admin side of the interface. For example, most clients are currently AHA and ASHI course users. In order to minimize the confusion created through multiple non-applicable courses, within the preferences, the applicable courses for that client are designated. Only those designated are presented to the client side of the interface.

Company Side>Admin Menu>Training

Overview

There is a direct relationship between the Training and Team sections of the system. The people who complete a Training courses are the people who populate the Team. As such, the system actively manages the process of obtaining training course data and processing the data for inclusion in the Team interface.

On rare occasions, a team member has existing training credentials and does not go through the system's Training interface. This is accommodated through the existing capability to add team members directly within the team interface.

Training Request Data

A client may request a training course through the client-side interface or the request may be initiated on behalf of the client on the admin side. In either case, this is the beginning of the data entry process. This “request” is then queued as an Action Item for the Training Coordinator.

The Training Coordinator completes the required information—confirming dates, courses, assigning instructor(s), etc. In rare instances, class participant names are known ahead of time. More often, they are not. As such, this data may not be available at the time the Training Request form is completed. An additional field is required to designate the participant as a recertification or not.

Course Types

Within a Training Request, there exists a set of fields for designating which courses are to be taught. This data currently is limited to the following, but must be expandable to accommodate additional categories (i.e. AHA and ASHI) and additional course types (i.e. BLS Healthcare Provider, Heartsaver CPR, etc.) as well as information specific to the course. Most likely a series of tables is required, one for categories, one for types and then finally a record for each course type initially containing the course name, official length of certification (generally two years), Premedics recommended length of recertification (generally 1 year) and more to be defined. The course types correlate directly to the “certifications” listed for each Team member.

American Heart Association

BLS Healthcare Provider (Child, Infant, & Adult) Certification

Heartsaver CPR (Child, Infant, & Adult) Certification

Heartsaver AED (with CPR) Certification

American Safety and Health Institute

Basic First Aid Certification

Emergency Oxygen Certification

Bloodborne Pathogens

Red Cross

None available yet.

Manufacturer

Philips Heartstream AED

Processing Training Request

There are three options from a training request—Update, Cancel and

Post to Team.

Update stores the data as a training order awaiting completion of the course if scheduled date and instructor data has been entered. If not, it is stored as a training request.

Cancel clears any changes made to the form.

Post to Team assumes that the course has already been taught and that the user intends to post the training course data to the Team records. It is important to note that the Post to Team function requires no confirmation of data, but a data validity check is required. Course date, instructor, course type, and participant names must all be supplied. This function is for initial data entry into the system and should not be used once initial data entry has been completed.

Once the scheduled date and instructor data has been entered, the “Request” becomes an “Order.”

Training Order Process

Training Orders are printed out for Trainers as part of their traveling documents. The Training Orders are viewable in a calendar interface. Mature Training Orders (those with scheduled dates prior to the current date) are managed as an Action Item for data entry into the Team interface.

Calendar Interface (Included as a reference, but part of version 2.0)

Within the Training Calendar Interface, scheduled courses are displayed. The interface defaults to display “orders” only. Clicking on a hypertext link allows the user to view “requests” only or to view both “requests” and “orders” within the same screen. “Orders” are displayed in black. “Requests” are displayed in gray (or another suitable color).

Action Item

24 hours after the scheduled course date, an Action Item is created for the Training Coordinator. This action item provides the Training Coordinator with a link to a course confirmation form where the Training Coordinator confirms the accuracy of data and/or provides missing/incomplete data (i.e. participant names, additional certifications, etc.).

Regardless of the number of participants, this interface accommodates twelve participants at a time. If there are more than twelve, the interface provides an option to allow an additional 12 participants at a time.

There are three options from a training order—Update, Cancel and Post to Team.

Update stores the data as a training order awaiting more information or completion of the course.

Cancel clears any changes made to the form.

Post to Team assumes that the course has already been taught and that the user intends to post the training course data to the Team records. It is important to note that the Post to Team function requires no confirmation of data, but a data validity check is required. Course date, instructor, course type, and participant names must all be supplied.

Certification Card Printing

Once a student has completed a course, they are presented with a certification card memorializing their training. These cards are printed on standard 8.5″×11″ card stock run through a printer and then punched out along perforations. There are three (3) different forms. Copies of these cards have been provided to Atiba through J. J. Rosen. Once a course has been completed, its participants are sent to a queue for the appropriate card printing. Printing of these cards may be best accomplished through the use of a .PDF file format though other solutions which are effective and efficient in terms of development and management time will be considered.

Team Data

Within Team, the confirmed Training Order Data is updated to the files. Each participant becomes a Team member. Each certification is designated as being held by the participant with the scheduled date of the course as the certification date.

Recertification

If a course participant is listed as a recertification, then the interface should prompt the Training Coordinator to check the existing roster for duplication of those team members and provide them a list of names in a dialogue box.

Equipment Dependencies

Not all clients have equipment. Some are training-only clients. As such, no dependencies exist between Training and the existence of Equipment data, nor between Team and the existence of Equipment data.

Company Side>Client View>Md

EMS

EMS Classification/Types

Various types of EMS personnel exist. The system logs all appropriate personnel by category as defined below:

EMS Director

Local Department

EMS Dispatcher

EMS Medical Director

PAD Program Medical Author

Other

EMS Notification Date

A date field is presented noting the date on which the Local EMS contact was informed and the name of the person to whom it was directed, the contact method and the contact information (i.e. fax number, e-mail address, regular mail address, etc.)

Version 1.2

Overview

These specifications are for version 1.2 of the Premedics Enterprise System (also referred to as FrontLine Enterprise System in previous documentation).

This is not a complete specification of the version 1.2 system, but a documentation of the version 1.2 enhancements to the initial specification and/or clarifications of functions specified in the version 1.0 documentation and version 1.1 documentation.

General Specs

Add County to Data Model

Client and ClientSub need additional field—county. In addition to state legislation, there is a significant amount of county legislation beginning to go into effect. Data entry for this data is through the initial client setup interface and editing is through the Company Side>Client View>Contact tab.

Client Side

Client Side>Program

AED User Report Submission Response Screens

After a user confirms and submits the data for an AED User Report, the response screen is a set of specific instructions with links. The instructions include a prompt to go to the equipment interface and update AED consumables inventory, a prompt to have event data clinically evaluated, link to a Return to Service Instructions, and a link to a Return to Service Report. If an oxygen use was also noted, the system prompts the user to file an Oxygen User Report.

Maintenance Log—Status Indicator Images

Maintenance log will be enhanced to use photographs and/or animated images of status indicator displays as well as text-based descriptions of status indicator display options. Since Status indicators vary by manufacturer, the interface presents the status indicator features specific to the client's installed products. For example, an FR2 displays a flashing hourglass, flashing X, solid X or black screen. The Zoll AED displays either a red “X” or a green “✓” (check mark).

Processes and Procedures

Read-only program procedures and protocols will be available in the Program section. As possible, these procedures and protocols will be pulled from a standard list of protocols. An admin user will select the applicable documentation. By selecting them, the documentation is made available within the client-side interface.

Data merge fields may exist within documents. Additional data input and/or queries from the existing data maintained for a client may be required. These will be utilized to customize process and procedure documents to each client. For example, if a document makes reference to installations by name, that data may be queried from the database and automatically inserted into the document for presentation to the client.

Processes and Procedures may vary according to equipment manufacturer.

A copy of standard Process and Procedure Documents is provided in the Appendix.

Order

Credit Card Processing

The online ordering interface will be modified to accommodate online credit card processing for orders placed through the site.

Equipment

Inactivated Equipment Locations

Equipment may be moved or removed for a variety of reasons. For example, CBL has moved a location due to remodeling. Potential client Rock Island Construction will move units between construction sites upon completion projects. For this reason, equipment locations need to be able to be inactivated. Inactivated locations are still available to both the client and the admin personnel since records must be maintained for a minimum of 5 years according to federal legislation.

Tracking Cabinet

Tracking of cabinet manufacturer/model and material.

MD

Polling of Good Samaritan Legislation Sites

The link to Good Samaritan Legislation should provide links to at least two different sites—early-defib.org and padl.org and preferably to the specific state listed in the ClientSub address.

These links should be monitored for ongoing changes to the sites which they reference. That data is in turn logged and provided to the client in two formats—as a link on the MD page saying “Check for Changes in Legislation which may effect your PAD program.” And in the monthly newsletter.

Company Side

Company Side>Client Menu

Contacts

Multiple Client Contacts

The system requires a single individual as the primary contact for the account, but allows for multiple client contacts.

Notes and Reminders

A Notes field logs contact information. The data logged includes date of event, type of event, text field, and reminder time frame. The reminder is set up as an Action Item directly related to the notes data.

Company Side>Admin>Action Items

Reassignment of Action Items

Action Items may be reassigned to other users with Admin privileges. Each reassignment is logged. In the event that a user attempts to reassign a task to someone to whom the task was already assigned, the user is given a prompt reminding them that the intended assignee has already had the action item, but is allowed to complete the task.

New Action Item—Recommended Training course within 90 days

When the system calculates a recommended training course time frame either calculated or the defaulted 1-year time frame, the training coordinator receives a notice 90 days in advance and subsequent 60 and 30 day notices up until a course is scheduled.

New Action Item—Pending Order Priority Status

As per the Client Side>Order>Pending Order feature described previously, a new action item provides an alert that a pending order item is not available on site for the client and therefore represents the single point of failure regarding a program's state of readiness.

New Action Item—Notes and Reminders

As per the Client Contact Notes Section.

Admin>Client

Additional data for ClientSub record: business hours, number of employees at location, LifeNet or other authority approval number (reference Saginaw docs).

The number of fields by which a client may be searched is to be limited to name, address, contact name, and client ID.

Admin>MD

MD Fax Option

MD notification will have both e-mail and fax options.

Overview of Version 2.0

Premedics is a provider of life-safety training courses and services and the associated life safety equipment (i.e. AEDs, Oxygen, etc.). Premedics is a customer service oriented business that has developed an automated business process in the form of a web-based software system. The initial version 1.0 was developed under the name of FrontLine Enterprise System (FLES) version 1.0.

Version 2.0 represents a major upgrade to version 1.0. At a high level, the effect of this modification is to better enable layperson usage through the use of wizards and improved interface, enhance the portability of the software, enhance the flexibility of the software and allow other distributors to make use of AED MANAGER™. The following issues comprise the most significant changes:

A conversion of the software to the .net programming language and the associated modularization of the code

Refinements to interface having proven functionality in version 1.0 with minimal interface development

Addition of new features more fully accommodating local, state and federal legislation; industry standards; and industry best practices.

This document provides a complete specification of version 2.0 utilizing reference to the existing and fully functional FLES version 1.0 system.

The software is available in both lite and full-featured versions. The primary distinction is that the full-featured version includes an Admin module enabling client management, order management, training center management, and reporting tools.

Platforms and Security

Platforms

AED MANAGER™ v. 2.0 is built using Microsoft's net programming language for ultimate portability among platforms. The initial execution platform is Windows 2000 Server running SQL SERVER as the database.

AED MANAGER™ is built to be portable to all major platforms including but not limited to WindowsNT, UNIX, and LINUX and to all ODBC compliant database solutions including Oracle, MySQL, etc.

The software is fully Internet enabled and is suitable for use on internal IP-based networks.

Security

Data security is intended via UserID/Password combination and 128-bit SSL encryption. Data integrity is maintained via regularly scheduled backups of the system and database to DAT and/or CD-ROM per the site host's service offerings.

Users may choose to operate the system without the recommended security measures within their own network at their own discretion and the system is enabled to accommodate that scenario.

Users

There are three primary user types:

Clients

Distributors

Software Support

Client users are users of the system who maintain and support a life safety program on a day-to-day basis. These users make a full range of the spectrum from healthcare professional, to management, to average blue-collar workers. Clients are either Corporate Clients or Program Coordinators. The primary distinction between Corporate Clients and Program Coordinators is that Program Coordinators have access to AED MANAGER™ specifically for their location. Corporate Clients have access to all AED program initiatives within their organization. All features available to Program Coordinators are available to the Corporate Client.

Distributor users are users of the system who are familiar with the distribution and/or implementation of life safety programs. These users may be medical professionals, salespeople, or service industry employees working in support of a life safety program.

Software Support users are users of the system administering the use of the AED MANAGER software package. These users are trained especially in the use of the system and are qualified experts on the AED MANAGER.

For the purpose of maintaining professional division of services and segregation of business, there may be no accounts with both Distributor Level and Software Support Level logins.

Since there is a series of users within the system at the same level who are unable to view one another's records, special consideration for handling of user names and accounts is required. Each distributor should have their own login gateway (i.e. http://xyzdistributor.premedics.com). The system should transparently append an identifying prefix or suffix to each user ID based on the page from which a user logs in thereby allowing the user to obtain account and user IDs unique within their own view of the system.

| | Sub- | |
|---|---|---|
| | User | UserID/Pass |
| Section | Groups | Protect |
| Clients | No | Yes |
| Distributors | No | Yes |
| Software | No | Yes |
| Support | | |

System Architecture

The system is comprised of a series of closely related modules overlaying a centralized relational database and/or a distributed relational database. Programmed as a .net application, the modules are designed to function independently, as a whole, or in any combination of modules. Those modules are paralleled closely in the user interface. Those modules are:

Set-Up and Initialization Wizard

Action Items

Program

Order

Training/Team

Equipment

Medical Direction

Preferences

Help

Dashboard

Activity Log

Readiness Report

Admin

Each module is capable of being activated or inactivated on a client-by-client basis. Because the data model is closely interrelated, the inactivation of modules may impact other modules.

Each module may have sub-modules (i.e. the Admin Module has Clients, Training Center, News, etc.).

Inactivating an Active Module

Active modules may be inactivated and vice versa. Inactivating a currently active module has significant implications. Because data may already exist in the previously active module, Action Items would still be generated off of the data no longer being actively maintained and therefore increasingly inaccurate over time. As such, inactivation of an active module disables all Action Items associated with the data in the inactivated module.

Activating a previously inactive module has implications as well. Since potentially no data exists, the user must be prompted to enter data appropriate for the newly activated section. This can be done via the Setup and Installation Wizard module described in this document.

User Interface

Overview

The existing FLES version 1.0 interface illustrates the core elements of the AED MANAGER™ v. 2.0 user interface. The user interface parallels closely the module structure of the AED MANAGER™ application. Many of the modules are a main menu tab or are a prominent feature within the user interface. Within each user level view, the main modules are:

| | | | Software |
|---|---|---|---|
| | Client | Distributor | Support |
| Module | Level | Level | Level |
| Set-Up and Initialization | Yes | Yes | Yes |
| Wizard | | | |
| Action Items | Yes | Yes | Yes |
| Program | Yes | Yes | Yes |
| Order | Yes | Yes | Yes |
| Training/Team | Yes | Yes | Yes |
| Equipment | Yes | Yes | Yes |
| Medical Direction | Yes | Yes | Yes |
| Preferences | Yes | Yes | Yes |
| Readiness Report | Yes | Yes | Yes |
| Activity Log | Yes | Yes | Yes |
| Help | Yes | Yes | Yes |
| Admin | No | Yes | Yes |

Client Level Interface

In the Client level user interface, the Main Menu is presented via a series of tabbed headers across the top of the interface. A column along the right hand side of the page displays an Activity Log of all recent significant activity within the AED MANAGER™ system. The remainder of the screen (framed by the Main Menu and Activity Log) is the Workspace where data entry and data presentation are accomplished.

[image]

Figure X.X: Screen Capture of v. 1.0 Client Level and General Interface.

Version 2.0 Interface Changes:

In the Client level user interface in version 2.0, “action items” will appear as the first tab in the main menu. The “training” and “team” tabs are combined into the “training” tab. Also, all tabs become icons with the title of the tab displayed only on rollover.

The Client level user interface will be redesigned to accommodate the unsophisticated user. The primary implications are:

Development of icons for the Main Menu tabs with rollovers displaying the tab title

Addition of a setup and initialization wizard for initial data entry on a program

Addition of a step-by-step wizard for setting up new ClientSubs and Installations at the Distributor level

Note: For Corporate Clients (as opposed to Program Coordinators), the sole distinguishing features are discernible in the initial interface. Corporate Clients are prompted to select the Location for which they wish to view the AED MANAGER™ from a list of the Locations associated with the Corporate Client. In addition on that same page, the Corporate Client user has the option to access their “Corporate Readiness Report” as defined in the Readiness Report section of this document.

Distributor and Software Support Level Interface

The Distributor and Software Support level interface is distinguished from the Client level interface by the addition of an Administrative Menu along the left hand side of the interface.

[image]

Figure. X.X: Screen Capture of v. 1.0 Distributor and Software Support Level Interface

Version 2.0 Distributor and Software Support Level Interface Changes:

In the Client level user interface in version 2.0, the “contact” tab will be removed when viewing a client record and the data will be moved to the “preferences” tab as in the version 2.0 Client level interface.

The “action items” link will be changed to read “all action items” and an “action items” tab will appear in the main menu interface when viewing a client record.

Lite and Full Versions

AED MANAGER™ is available in a lite- and a full-featured version. The lite version does not include the Admin module containing client management, order management, training center management, and reporting tools. The lite user version is simply the client side interface with no Admin Side login made available at the Distributor level.

The limited feature version is ideal for the independent instructors such as that represented by the AED Instructor Foundation (AEDIF). The lite version enables an instructor and program implementer to properly fulfill their AED program on an installation-by-installation basis. An instructor may manage multiple installations with the lite version, however the instructor must log in for each installation separately and has no access to the administration tools. This product provides a natural entry point for users who may wish to upgrade or graduate to the full feature version in order to facilitate their ability to manage a growing installed base of clients.

Activation of the full feature version requires the assignment of a UserID/Password from the software support level. Within the software support level, the system administrator may assign previously client side managed accounts to a distributor.

AED Manager Setup and Initialization Wizard

The AED MANAGER™ Setup and Initialization Wizard walks the user through the initial data entry process each time as if the user were a first time user. The system prompts the user by providing a graphical guide to where they are in the setup process and indicating the progress of the user.

System setup is a five (5)-step process. A high-level view of the data collected in each of those steps is provided below. If a user is unsure what data is being requested, they may receive an explanation in a separate frame at the bottom of the browser similar to that found on the USPTO.gov web site when registering for a trademark.

Step 1: Client Information

Company Name

Corporate Manager Name

Corporate Manager Information

Location Name or Description

Program Coordinator Name (may select “Same as Corporate Manager Name”)

Program Coordinator E-Mail

Program Street Address

City

State

Zip

Step 2: AED Specific Data

Installation Location Description

AED Brand and Model

AED Serial Number

Accessories (as a pop-up after inputting AED model)

Batteries

Lot or Serial #

Expiration or Use by Date

Installed on Date

Pads (Adult and/or *Pediatric) * Not applicable to all AED models.

Lot or Serial #

Expiration or Use by Date

*Data Card

*Expiration Date

Step 3: Training

Team Members Names

Shift(s)

Primary Installation

Certification(s)

Certification Date(s)

Training Solution Provider (i.e. Trainer Name)

Step 4: Medical Direction and Preferences

Select Medical Direction Provider

Medical Director Name (If not Premedics)

Medical Director Contact Information

Medical Direction Contract Term

Prescribing Physician Name (If not Premedics)

Prescribing Physician Contact Information

Frequency of AED Status Checks (Default set to manufacturer's recommendation)

Certification Organizations (Default set to American Heart Association only?)

Step 5: Status Report

Fill out Status Report

Completion Prompt

After Step 6, AED MANAGER™ prompts the user to take the tour of the system and provides them with a quick list of the things they need to do on a regular basis and what they can expect AED MANAGER™ to do for them. The user may print this document out or will find it available under the Help tab.

Activation of a Previously Inactive Module

If a previously inactive module is activated after the initial running of the Setup and Installation Wizard, then the Wizard runs again. Previously entered data should pre-populate the fields requiring only user confirmation of the data entered.

Action Items

Overview

Action Items are an AED program management tool. The Action Items tool guides the user via a prioritized view of their AED program needs. The interface is a drill down allowing the user to immediately identify the appropriate steps to be taken in managing their AED program via a single click. Action Items are prioritized according to their relative significance in maintaining an AED program in a state of readiness.

Action Items are displayed in a table format defaulted to display by priority. Users are able to resort the Action Items by clicking on a column header. The interface for Action Items remains functionally unchanged from the FLES version 1.0 interface presented below.

[image]

Figure X.X: Screen Capture of v. 1.0Action Item Display on Admin Side of Interface.

AED MANAGER™ initiates Action Items based on the data supplied by system users and/or collected via networked access (i.e. wireless, infrared, cellular phone, radio, cable, etc.) to the AED and/or its accessories. AED MANAGER™ evaluates the data against acceptable parameters set in the system as a preference and/or stored as industry standards and/or stored as state/local/federal legislative requirements. When a value falls outside of an acceptable range, the result is the generation of an Action Item added to the Action Item queue. The Action Item queue performs several functions:

Notifies a user that a program is not in a state of readiness or is approaching that status

Prompts the user with an appropriate response to reestablish readiness

Prioritizes actionable tasks for reestablishing readiness based on potential liabilities

The chart below provides an overview of the Action Items initiated by AED MANAGER™ in establishing and maintaining an AED program in a state of readiness. This is a comprehensive list of Action Items as are applicable to all user levels. Client level Action Items are strictly focused on maintaining a program in a state of readiness. Distributor and Software Support level Action Items include all Action Items available at the Client level as a matter of customer support. In addition, the Distributor and Software Support level also include additional Action Items used for training center management and extended customer support.

Action Items are queued in a list for users to view and obtain information regarding the actionable tasks required in order to address an Action Item. Action Items may also be directed to users via e-mail notification. Use of e-mail notification does NOT alleviate the appearance of the Action Item from the Action Item queue.

Version 3.0 Feature: Action Item notification may be directed to an alphanumeric beeper, PDA, automated telephone system or other communications device(s).

| | | | | | | Software |
|---|---|---|---|---|---|---|
| | | | | Client | Distribut | Support |
| Action Items | Recipient | Priority | Version | Level | or Level | Level |
| | Account | | | Yes | Yes | Yes |
| AED Status Indicator Alert | Manager | 1 | 1.0 | | | |
| Oxygen Indicating Less Than | Account | | | Yes | Yes | Yes |
| 15 Minutes | Manager | 2 | 1.0 | | | |
| | Account | | | Yes | Yes | Yes |
| Daily Status Report Not Filed | Manager | 3 | 1.0 | | | |
| Below Threshold of Trained | Account | | | Yes | Yes | Yes |
| Personnel per Shift | Manager | 4 | 1.0 | | | |
| AED Return to Service Not | Account | | | Yes | Yes | Yes |
| Filed | Manager | 5 | 1.0 | | | |
| Oxygen Return to Service Not | Account | | | Yes | Yes | Yes |
| Filed | Manager | 6 | 1.0 | | | |
| AED Equipment Usage - | Account | | | Yes | Yes | Yes |
| Acknowledge Report | Manager | 7 | 1.0 | | | |
| | Account | | | Yes | Yes | Yes |
| Battery expiring: xx/xxx | Manager | ? | 1.1 | | | |
| Pads expiring xx/xxxx | Account | ? | 1.1 | Yes | Yes | Yes |
| | Manager | | | | | |
| Oxygen Equipment Usage - | Account | | | Yes | Yes | Yes |
| Acknowledge Report | Manager | 10 | 1.0 | | | |
| PreEMS Program Checklist | Account | | | | | |
| Not Filled Out Properly | Manager | 13 | 3.0 | | | |
| | Training | | | No | Yes | Yes |
| Training Request (Existing | Coordinator | 14 | 1.0 | | | |
| Client) | | | | | | |
| | Product | | | Yes | Yes | Yes |
| Order (Existing Client) | Coordinator | 15 | 1.0 | | | |
| | Account | | | | | |
| Version 1.x Training Request | Manager | 16 | 3.0 | | | |
| | Account | | | | | |
| Information Request | Manager | 17 | 3.0 | | | |
| Order Not Shipped - Aged 5+ | Account | | | No | Yes | |
| Days | Manager | 18 | 3.0 | | | |
| | Account | | | Yes | Yes | Yes |
| Order Shipped | Manager | 19 | 1.0 | | | |
| Instructor Recertification | Account | | | No | Yes | |
| Date | Manager | 20 | 2.0 | | | |
| Change of Course Information | Account | 21 | 3.0 | Yes | Yes | |
| | Manager | | | | | |
| | Account | | | No | Yes | |
| Change of Employee Status | Manager | 22 | 3.0 | | | |

AED Status Indicator Alert

AED MANAGER™ checks Status Reports and AED Post User Reports as they are submitted for confirmation of a functional status indicator. In the event that user supplied data indicates a marginally functional or non-functional unit, the user is prompted to confirm the data and take appropriate steps to address the deficiency. If the data is confirmed as being accurate, AED MANAGER™ generates an IMMEDIATE Action Item. The system continues to check the data when running its usual chron job and generates additional daily warnings as appropriate.

Oxygen Indicating Less Than 15 Minutes

Identical to the “AED Status Indicator Alert” notification as applies to oxygen.

Status Report Not Filed

The status indicator reading is required to be recorded periodically. The interval for the periodic reporting is set under the Preferences tab. The user can set their preference for the frequency with which they file a status report to daily, weekly, or monthly. If a report is not filed within 24 hours the defined time period, AED MANAGER™ generates an Action Item. AED MANAGER™ continues to check for a Status Report every 24 hours and the Action Item remains active or is reactivated if it has been dismissed, but not report exists to cover the time period in question.

Below Threshold of Trained Personnel per Shift

The number of trained personnel (Team Members) per shift is a client-specific designation of the number of personnel required to be trained in the use of an AED during any given shift. The threshold is set under the Preferences tab. As Team members are inactivated and/or certifications reach their expiry date, the number of trained personnel may reach the predetermined threshold. AED MANAGER™ checks every 24 hours to ensure that sufficient trained staff exist. If sufficient trained staff does not exist, AED MANAGER™ generates an Action Item prompting that a potential training need exists.

AED Return to Service Not Filed

Following an AED use, a client must follow the Post Use Instructions Form and complete the AED Return to Service Form within 24 hours. A chron job checks to see that an AED User Report has an associated AED Return to Service Form posted within 24 hours of the posting of the AED User Report. If the AED Return to Service Form is posted, the notification reflects that fact. If not, the system continues to send a notification once daily until the AED Return to Service Form is completed. The notification includes the option for the Action Item recipient to send an automated e-mail to the registered Program Coordinator for the client prompting them to complete the appropriate form. This effectively eliminates that instance of notification, however subsequent daily notifications are initiated and appear as Action Items in the event that the form continues not to be completed.

Oxygen Return to Service Not Filed

Functions for Oxygen identically as above for “AED Return to Service Not Filed.”

AED Equipment Usage

The recording of an equipment usage via an AED User Report automatically generates an Action Item. The Action Item prompts the user to acknowledge the report and provides a prompt of task(s) which the should ensue:

Acknowledge Report—AED MANAGER™ prompts the user to acknowledge the report, update their accessories inventory, refer to the Post Use Instructions for their AED and promptly file an AED Return to Service Report.

MD Informed—AED MANAGER™ automatically informs the MD via e-mail. The prompt includes the phone number of the Medical Director for any further questions.

Oxygen Equipment Usage

Functions for Oxygen identically as above for “AED Equipment Usage”

Pads Expiring

Pad expiration date (or Use by Date) is recorded when accessories are added to the inventory of an installation. AED MANAGER™ checks the pad expiration date at regular intervals to ensure that all accessories are still within their dates of validity. At a set period of time prior to the conclusion of their period of validity, AED MANAGER™ generates an Action Item prompting the updating of the inventory records and/or a purchase of pads to fulfill the inventory needs.

Battery Expiring

Battery expiring functions for batteries identical to the manner in which Pads Expiring works for pads. Battery expiration date (or Use by Date) is recorded when accessories are added to the inventory of an installation. AED MANAGER™ checks the battery expiration date at regular intervals to ensure that all accessories are still within their dates of validity. At a set period of time prior to the conclusion of their period of validity, AED MANAGER™ generates an Action Item prompting the updating of the inventory records and/or a purchase of battery/-ies to fulfill the inventory needs.

A new action item forecasts and anticipated/expected expiration date for batteries. A formula calculates the expected expiration date. Expected Expiration Date=Battery Installation Date+each specific manufacturers' expected battery life. (This date can also be entered/generated in a field upon setting up a new client under what is currently called Expiration Date for the Batteries—Currently there is an Expiration Date and an Install By date that is being logged—Currently I put the same date for these fields).

A disclaimer in the Action Item will need to be added stating various things such as “this is assuming no usages using the batteries.” This will take the place of the current Action Item that states battery will expire on xx/xx. Currently, this action item is grabbing the “install by” date and thus it is inaccurate.

Life Safety Program Checklist Not Filled Out According to Schedule

The Life Safety Program Checklist is filled out monthly and posted. If it is not posted within 32 days of the most current Checklist (note need for exception in programming on first instance), a notification of that fact is made.

Training Request (Existing and Potential Client)

A client or potential client initiates a training request through a form page. The FrontLine primary recipient receives the information as a pre-filled form page. The form page is identical to the one used for scheduling a new course in the Courses in the Company-Restricted section.

Version 1.1 Feature: In the event of a potential client request, the information also includes account information in order to initialize a new account during the entry process in addition to the training details request.

The FrontLine representative is required to process the information, finalize the details (time, availability, number of employees, etc.) and confirm the data before it is posted to the system as an actual training course. The data undergoes an integrity check prior to posting in the database. On posting to the database, a confirmation e-mail of the details of the training course is sent to the client's e-mail as registered with FrontLine.

A user may opt to cancel a Training Request if the request is not or cannot be fulfilled.

Information Request

An information request comes from the Public section, the Client-Restricted section or may be taken as an incoming phone call. The information is processed into a page for viewing and assigned to the staff member responsible for new accounts manager. The staff member is responsible for verifying sufficient data from the request in order to establish a new client account and for responding to the request or assigning the task to another party.

Instructor Recertification Due

A chron job periodically reviews each instructor's recertification dates. As recertification dates for an instructor approach, the Training & Support Coordinator receives a 90-60-30 then ongoing weekly reminder. If an Instructor does not have a certain given certification, the system does not prompt the Training & Support Coordinator for a recertification.

Change of Course Information

The change of course information notes changes to the course at the top of the notification and restates the course details in full.

Change of Account Information

The change of account information notes changes to the account at the top of the notification and prompts the account manager.

Call Client if data appears to require a call.

Check for data integrity.

Change of Team Member Status

The change of Team Member status notes changes to a Team Member's status by an employer.

User Level Distinctions—Action Items

Client Level

The default home page for the Client level user is the Action Items view. The client side Action Items view is a subset of the Action Items available to the Distributor and Software Support levels. The Client level Action Items includes those Action Items as indicated in the chart above.

In version 2.0, AED MANAGER™ provides a client-side view of Action Items. For this enhancement, Action Item copy is modified from the format presented in v. 1.0 to a format suitable for presentation to clients.

E-Mail Notification of Action Items

AED MANAGER™ e-mails notification of Action Items. E-Mail notification is done in addition to queuing the Action Items for a client side view. Copy varies slightly from that used in the client side view of the Action Item queue. E-Mail notification of Action Items to the Client may be disabled/enabled within the Distributor level of Software Support level Preferences, but NOT at the Client level as a Preference option. Disabling the e-mail notification of Action Items may be accomplished by eliminating the client's e-mail address from the client record.

Extended Period of Inactivity E-Mail Notification

AED MANAGER™ generates an e-mail if the client has an extended period of inactivity with the AED MANAGER™. The e-mail is generated if a user has not logged on to the system within a period of time defined under the Preferences tab. The Distributor level contact is cc'ed on this e-mail. This option may not be disabled.

Fax Notification of Action Items

The system escalates Action Items that remain active beyond a predetermined period of time. The escalation results in a fax-based communication of the same information contained in the Action Item e-mail detailed above. This feature may be disabled/enabled within the Distributor level Preferences tab.

Distributor Level

Distributors are defaulted to receive the Action Items sent to their clients. If the Distributor is not the Medical Director, this feature may be disabled. Action Items remain as in the current version with minor modifications to copy regarding Premedics-specific action recommendations and specific reference to Premedics.

E-Mail Notification

Distributors receive the same e-mail notification as is sent to the client. Within the Admin Preferences section, this option may be disabled.

Software Support Level

Action Items escalate to the Software Support Level only if the client is a PremedicsMD client.

Checklists/Forms

Overview

The Checklist tab (formerly the Program tab in version 1.0) provides the necessary forms and process/procedure documents required for the execution of an AED program. The user selects the form that they require. AED MANAGER™ presents them with the appropriate form according to the managed program's information as it is recorded in AED MANAGER™.

[image]

Figure X.X: Screen Capture of v.1.0 Program Tab with Drop Down Box of Options Displayed.

If the client has no oxygen or AED installed, but only has training, they should receive only thc appropriate forms as options. For example, a client with an AED but no oxygen solution should not receive as options the Oxygen User Report, Oxygen Post Use Instructions or the Oxygen Return to Service Report.

AED Status Report

The AED Status Report is unique to each manufacturer. The AED Status Report is a formal record that the AED status indicator is checked at a predefined interval. If more than one unit is installed in a location, the user is prompted to identify the unit for which they wish to provide a status report. The user is presented with an image depicting the various status indicator options as defined by the manufacturer of their installed AED (i.e. For a Philips FR2 AED, the options are a blinking hourglass, flashing red X, solid red X, or blank screen). The user selects the most appropriate image.

The frequency of this report is either daily, weekly, monthly. This parameter is set in the Preferences section and the interface presented to the client corresponds with this parameter. Users may fill in data for any past dates at any time, but not for any future dates. Those entries are time date stamped for record-keeping purposes.

AED User Report

AED User Reports are unique to each state and often times to a county. AED MANAGER™ presents the state/county appropriate form. This is done through an XML standard developed by Premedics. Premedics has developed and maintains a clearinghouse of the questions appearing on state-required and specific county-required AED User Reports. A wizard at the Software Support level allows a Software Support level user to define each state's default form. This is done by selecting the appropriate question from the inventory of questions and designating the order in which the questions should appear on the form. AED MANAGER™ then generates the state's default AED User Report from this data.

Some counties (counties as used in the framework of the AED MANAGER™ refers to the generic division of states into their next level of localized governance including parishes and precincts) have developed and implemented their own AED User Reports. On an exception basis, the Software Support level user may elect to provide a county specific form as an override option to the default state form. The county specific form is developed using the same question inventory and wizard as the state default User Reports utilize. Clients in counties with an established standard should be presented with their county specific AED User Report form.

[image]

Figure X.X: Screen Capture of v. 1.0 Program Tab>User Report Option Selected with Standard Default User Report Form Displayed.

XML Standard

Premedics will develop an XML standard for the storage of AED User Report data. Premedics' staff will conduct a comprehensive survey of available AED User Forms and assemble a comprehensive list of questions and the data format in which the answers to those questions are recorded.

An interface allows a user at the Software Support level to select which questions are applicable as a default for each of the US states and/or territories. The user selects the appropriate questions and a default AED User Form is generated by the system. The user may also opt to rearrange the order of the questions to more closely approximate the ordering of the state's form.

Additionally the interface will allow the Software Support level user to note county-by-county exceptions to the state/territory's default. For those exception counties, the Software Support level user may create an AED User Form by selecting from the comprehensive question bank a series of questions that most closely approximates the forms of the exception county.

This data may be used as clinical research data regarding AED usage.

AED Post Use Instructions

AED Post Use Instructions are specific to the manufacturer. AED MANAGER™ selects the appropriate Post Use Instructions based on the installed equipment for the client as indicated under the Equipment tab. If more than one model is installed, the user is prompted to identify the specific model for which they require the Post Use Instructions and the appropriate instructions are displayed. If only one unit is installed, the appropriate form for that unit is automatically presented.

[image]

Figure X.X: Screen Capture of v. 1.0 Program Tab>Post Use Instructions Selected with Philips FR2 Standard Post Use Instructions Displayed.

AED Return to Service Report

An AED Return to Service Reports is specific to the manufacturer. AED MANAGER™ selects the appropriate Return to Service Report based on the installed equipment for the client as indicated under the Equipment tab. If more than one unit of the same model is installed, the user is prompted to identify the specific unit. If only one unit is installed, the appropriate form for that unit is automatically presented.

[image]

Figure X.X: Screen Capture of v. 1.0 Program Tab>Return to Service Form Selected with Philips FR2 Standard Return to Service Form Displayed.

AED Program Workbook

The AED Program Workbook is a procedures and protocol manual for the program implementer. The workbook consists of a standard format document. Premedics has developed and maintains a profile of AED legislation across the country. The profile is distilled down to 40+ issues (See Appendix X) regarding the implementation and management of AED programs. A wizard at the Software Support level allows a Software Support level user to define each state's profile in relation to the 40 issues. This is done by selecting the appropriate response to the question for each state. AED MANAGER™ then generates the AED Program Workbook specific to each state's profile.

Oxygen

Oxygen should be removed from the checklist unless specifically indicated as an element of the client's program.

User Level Distinctions

Client Level

At the Client level users have the ability to complete forms and interact fully with the system. Completed forms are presented as read-only forms.

Distributor Level

At the Distributor level users have the ability to complete forms and interact fully with the system. Completed forms are presented as read-only forms, and an option to edit the forms is available at the Distributor level.

Software Support Level

At the Software Support level users have the ability to complete forms and interact fully with the system. Completed forms are presented as read-only forms, and an option to edit the forms is available at the Software Support level.

At the Software Support level, a user may use the wizard to establish AED User Report state defaults and county exceptions.

At the Software Support level, a user may use the wizard to establish AED Program Workbook state defaults.

Independent Module Notes

If the Equipment Tab is Not Activated

If the Program tab is activated, but the equipment tab is not, the user has access to the generic AED User Forms for their state/county. The AED model and serial number information will be left as a text field for entry of the appropriate data. The form will be stored and the Action Items updated to reflect the completed form.

The Post Use Instructions and Return to Service forms are manufacturer specific. AED MANAGER™ prompts the user to select a manufacturer model, the presents the appropriate forms. As with the User Form, the AED model and serial number fields are left as text fields for appropriate data entry since the Equipment tab is inactivated and no reliable data may be extracted from the inactivated tab's data fields.

Order

Overview

The Order section is similar to version 1.0. Each user is presented with equipment information corresponding to their program equipment. If the program deploys more than one model of AED, then a list is provided from which the user may select the model for which they wish to place an order. If only one AED model is deployed, the user is immediately presented with a list of AEDs and accessories that match the model deployed in their program. Additionally, the user is provided with a list of other AED models from which they may select if they have an unregistered AED model for which they wish to purchase supplies.

Orders are accumulated into a shopping cart. Placement of the order is executed and queued into the administrative area and notification sent to the Product Manager via an Action Item as well as e-mail (if enabled).

[image]

[image]

User Level Distinctions

Client Level

No distinction.

Distributor Level

No distinction.

Software Support Level

No distinction.

Training

Overview

For AED MANAGER™ version 2.0, the “Training” and “Team” tabs have been combined under the “Training” tab. Since the functionality of these two tabs entwines so closely, their integration presents a more viable independent module than as separate modules. In addition, the integration of the two provides a means by which to simplify the user interface.

[image]

Figure X.X: Screen Capture of v. 1.0 Training Tab Display.

[image]

Figure X.X: Screen Capture of v. 1.0 Team Tab Display.

Combined Interface

At the top of the Training tab, the user will continue to be presented with a text-based prompt identifying the estimated next training date required by

Welcome [User Name]
[Client Company Name]
Training Session scheduled for: [Date]
At: [Location]
AED MANAGER ™ recommends that your next training session be
scheduled on or around [Date] based on the interval between past sessions.
You may need to schedule for recertification sooner if you have fewer than
three trained team members during any period of business operation.

the client (as in Figure X.X). Both the font size and the message for this prompt are shortened in deference to the addition of the Team data displaying the training record for each of the team members. The prompt reads as follows:

The interface for the Team data is simplified for version 2.0. Instead of displaying the names of the course as column headers (as in Figure X.X), the generic requirements for a company's life-safety program will appear as the column headers. This allows an organization to accommodate multiple training organization credentials within the same interface and provides a cleaner means by which to make an assessment of training needs for the layperson. A sample of how the data is organized is provided below. A complete list is provided as an addendum to this document.

| Organization | Course | CPR | AED | Oxygen | First Aid | BBP | Healthcare |
|---|---|---|---|---|---|---|---|
| American Heart | Heartsaver | Yes | | | | | |
| Association | CPR - Adult | | | | | | |
| American Heart | Heartsaver | Yes | | | | | |
| Association | CPR - Child/Infant | | | | | | |
| American Heart | Healthcare | Yes | Yes | Yes | | | Yes |
| Association | Provider | | | | | | |

Premedics Staff will be responsible for providing a comprehensive matrix of the relevant training courses available though the following:

American Heart Association (AHA)

Red Cross (RC)

American Safety and Health Institute (ASHI)

Medic First Aid

National Safety Council

In the Team interface viewable by the client, the Certification name (i.e. Heartsaver AED) and date of certification will appear in the space currently occupied by only the date. This will allow for a simpler approach to the interface for programming purposes and will allow clients to accommodate multiple training organization certifications (healthcare professional organizations present a higher likelihood of this occurrence i.e. staff with preexisting certifications).

If an AED is listed for the installation, AED and CRP training should be default required.

In addition to this information, the Training Solution Provider data is displayed in the Training section. This data is gathered in the Setup and Installation Wizard and is made available for editing in the Training tab section.

User Level Distinctions

Client Level

If no Distributor level for an AEDIF client, the Request Training function should e-mail the Training Solution Provider as identified by the Client in the Setup and Installation Wizard or as edited under the Training tab.

Distributor Level

Within the training interface, there are five potential certification organizations offering a range of courses. These organizations include:

American Heart Association (AHA)

Red Cross (RC)

American Safety and Health Institute (ASHI)

Medic First Aid

National Safety Council

Within each of these organizations there is some variation in terminology for equivalent courses. Premedics will provide a complete list for development of v. 2.0 (See the Team tab specification in this document).

A distributor may select any combination or any single certifying organization on a client-by-client basis for presentation to the client. Selection of a specific type of certification remains a privilege reserved for the distributor level. For example, if the distributor is a Red Cross training facility, they may wish to present only Red Cross courses to their clients.

Unless otherwise specified, the interface defaults to present ALL organizations' training courses.

Software Support Level

The software support level offers no additional functionality in this version. In a future version, the functionality to add/edit/delete courses and organizations will be added.

Independent Module Notes

If the equipment tab is not activated then the Action Item function determining if sufficient staff exists for each installation should assume a single location and base the threshold standards on the ClientSub as a single installation. In other words, for a training only client (i.e. no equipment) the threshold is an absolute number to be compared against the total number of trained employees.

Equipment

Overview

The equipment tab catalogs all of the AED and AED-related equipment associated with an installation. Within the Equipment tab, there are no menus rather there is a list of installations (instances of separate and distinct AED installations within a single physical address).

A User is prompted to enter the Equipment data in the Setup and Initialization Wizard. Within the Equipment tab, the user may update and/or edit the data pertaining to their equipment. This includes

Edit the Installation Description

Inactivate an Installation

Edit AED Accessories Information

Designate Accessories for Removal from Inventory

Add New Accessories Inventory

Edit Accessories Lot # and/or Expiration Date

Distributor level and Software Support level users have additional privileges enabling them to:

Edit the AED Serial Number

Edit the AED Model

[image]

Figure X.X: Screen Capture of v. 1.0 Equipment Tab Displaying a List of AED Installation from Which the User May Select.

[image]

Figure X.X: Screen Capture of v. 1.0 Equipment Tab with a Specific AED Installation Selected.

[image]

Figure X.X: Screen Capture of v. 1.0 Equipment Tab with the Accessories for a Specific AED Installation Selected.

Zoll-Specific Equipment Profiles

Zoll-Specific equipment profiles must be incorporated into the system. This includes pads and batteries. Like most other manufacturers', Zoll's pads have a lot number and expiration date. In a distinct departure from other manufacturers, Zoll allows the use of consumer available batteries. Each unit requires twelve D-Cell rechargeable batteries. The implications for the system are as follows:

Zoll recommends and warranties their equipment only with the use of Kodak and Duracell batteries. The system will allow the user to specify what brand they are using from the following list

Duracell

Kodak

Other (Note that other brands void the manufacturer's warranty and indemnification)

While each battery may have a different expiration date, Zoll specifies that all of the batteries MUST have the same expiration date or the user voids their warranty and loses the manufacturer's indemnification. The system will track a single expiration date for all batteries and offer a comment beside the data field noting that all batteries must have the same expiration date according to the manufacturer's specifications.

Since battery lot numbers may vary where expiration date may not, the system will not track battery lot numbers for Zoll AEDs.

Other specific issues yet to be identified may exist for Zoll products. Further issues are pending review of the Zoll User's Guide.

Equipment Data Model Issues:

Battery Installation Date and Estimated Battery Life Span by Battery Model

A field records the month and year (MM/YY) a specific battery or set of batteries was installed into an AED. The field should be titled “Battery Installation Date.” Only one battery may have a Battery Installation Date for each AED. Entry of a date should prompt the user to first denote another battery as disposed of. The Battery Installation Date will have to be added as part of the initial setup by the end user as a required field. This field will be used to forecast the expected expiration date of batteries.

The additional implication of this data is that each battery type (by manufacturer and model) will be required to have an Estimated Battery Life Span by Model associated with it. This is the other portion of the equation used to calculate the Action Item, Battery Expiration Date.

User Level Distinctions

Client Level

In a departure from the v. 1.0 functionality, Client level users are able to add/edit any and all data pertaining to equipment. This includes the ability to specify new installations; input AED models, serial numbers, accessories, serial numbers, lot numbers, install by and expiration dates.

NOTE: Opening this data entry capability to the client side results in a high potential for GIGO (Garbage In Garbage Out) scenario in which the data contained in the database is not properly monitored and controlled to provide viable data in mission critical systems—i.e. use by 9-1-1 dispatchers.

Distributor Level

Mirrors the Client level.

Software Support Level

Mirrors the Client level.

Independent Module Notes

| | | |
|---|---|---|
| None | so | far. |

MD

Medical Direction

The Medical Director tab contains information on the pertinent medical direction contacts for the AED program client and information on state/territory legislation impacting the AED program.

The user is prompted to enter the MD-related information in the Setup and Installation Wizard. Within the MD tab, the user may view and/or edit the data pertaining to Medical Direction for their program. This includes

Medical Director Contact Information

Local EMS Contact Information

State Legislative Issues

[image]

Figure X.X: Screen Capture of v. 1.0 MD tab.

Medical Director

Medical Director information includes the Prescribing Physician contact information and the Medical Director's contact information. The interface for maintaining this information remains virtually unchanged from the FLES version 1.0 interface.

For each location, the user is required to identify its medical director as one of the following:

PremedicsMD

Distributor-Managed Medical Direction

Client-Managed Medical Direction

The implications of this selection are primarily in the escalation of Action Items as noted below:

Clients MAY NOT disable receipt of Action Items.

The Distributor level has the option to disable Action Items if they are NOT the Medical Director.

The Software Support Level has the option to disable Action Items if they are NOT the Medical Director.

One further implication is that if either the Distributor-Managed or the PremedicsMD option is selected, the Medical Director information becomes locked uneditable data for the Client. Only by returning to the interface and selecting Client-Managed does the data become editable.

Important Note: If the PremedicsMD option is selected, the Medical Director information becomes locked and uneditable data for the Distributor level also. The only means by which to unlock the Medical Director data is to change the Preference specifying PremedicsMD as the Medical Director.

Local EMS

Local EMS information includes the local EMS contact information and a check box to confirm the form of notification to the local EMS authority. The interface for maintaining this information remains virtually unchanged from the FLES version 1.0 interface other than the addition of a checkbox to identify the method of notification.

State Legislative Issues

The State (and/or Territory) Legislative Issues are a series of issues on which information is actively maintained. This information is culled from each state's legislation regarding AED programs. Within the Software Support interface, a wizard allows an administrator to define which issues apply on a state-by-state basis. The current list consists over forty (40) different issues. When an issue is identified in the wizard as applying to a state, that issues is displayed in the Client and distributor level interfaces. When an issue is identified as not applying, the issue is not displayed in the Client or the Distributor level interface.

User Level Distinctions

Client Level

On the client side, EMS notification is accomplished via an automated function that ties the zip code of the installation address to a predefined list of EMS systems. The user has the ability to override the system default. A new feature on the EMS Notification allows the user to push a button to reset the local EMS data to the system default for their zip code.

Within the MD interface, Premedics will attempt to acquire and/or compile a complete listing of EMS systems and their appropriate contact information for inclusion in the system. This will enable the automation of certain functions as described below.

Failing the acquisition of such a list, the input of the EMS data becomes a client side or distributor level data entry task. Premedics use exception reporting to identify EMS systems using the AED MANAGER, but not yet appearing in the system to prompt a manual review of the data.

Distributor Level

On the distributor level, EMS notification is accomplished via the same automated function used on the client side. This function ties the zip code of the installation address to a predefined list of EMS systems.

The user has the ability to override the system default. A new feature on the EMS Notification allows the user to push a button to reset the local EMS data to the system default for their zip code.

Software Support Level

Mirrors the Distributor level interface.

Preferences

Overview

In version 2.0, the Contact tab (Admin side interface version 1.0) and Preferences tab data have been combined under the single Preferences tab. As a result, the data previously contained under the Contact tab in version 1.0 and available only on the Admin side of the interface is available to the Client level also.

The Preferences section is used to provide an interface for contact information for a client and for determining the parameters and settings for the customization of a client's AED MANAGER™. These settings are used to enable/disable the independent modules of the AED MANAGER™ and to define the parameters and thresholds of performance for the system including tolerances for quantifiable data recorded in the AED MANAGER™.

[image]

Figure X.X: Screen Capture of v. 1.0 Preferences Tab Display.

[image]

Figure X.X: Screen Capture of v. 1.0 Contact Tab Display.

Contact Data

The contact data remains as in version 1.0. Additions to this data one the Distributor and Software Support levels are noted in the User Level Distinctions section.

Preferences

The preferences to be set are as follows:

| | | | | Software |
|---|---|---|---|---|
| Preference | Option | Client | Distributor | Support |
| E-Mail Action Items | Enable/Disable | No | Yes | Yes |
| Escalation of Action | Enable/Disable | Yes | Yes | Yes |
| Item to Fax | | | | |
| Receive Readiness | Checkbox | Yes | Yes | Yes |
| Report via E-Mail | | | | |
| Frequency of Status | Daily/Weekly/Monthly | Yes | Yes | Yes |
| Reporting - Check one. | | | | |
| Preferred Training | American Heart Association, | Yes | Yes | Yes |
| Organization(s) - | ASHI, Red Cross, Medic | | | |
| Check all that apply. | First Aid, Nat'l Safety | | | |
| | Council | | | |
| Medical Direction | Premedics MD, Distributor- | Yes | Yes | Yes |
| | Managed, Client-Managed | | | |
| Checklist Tab | Enabled/Disabled | No | Yes | Yes |
| Order Tab | Enabled/Disabled | No | Yes | Yes |
| Training Tab | Enabled/Disabled | No | Yes | Yes |
| Equipment Tab | Enabled/Disabled | No | Yes | Yes |
| MD Tab | Enabled/Disabled | No | Yes | Yes |

User Level Distinctions

Client Level

As described.

Distributor Level

Client E-mail Notification of Action Items

The distributor is able to determine if a client is to receive automated e-mail notification of select Action Items (as detailed in the section on Action Items). The default setting is to not receive the e-mail. Note that fax may be set as a preferred notification method over e-mail.

Client Fax Notification of Action Items

The distributor is able to determine if a client is to receive automated fax notification of select Action Items (as detailed in the section on Action Items) that remain active beyond a set period of time. The default setting is to not receive the fax. Fax may be set as the preferred notification method over e-mail.

Distributor E-mail Notification of Action Items

The distributor is able to determine if they receive automated e-mail notification of Action Items as they relate to their client(s). The default setting is to not receive the e-mail.

Additional Data

Additional data is available to both the Distributor AND Software Support level users. This data includes:

Account Manager (selected from a drop-down list of account managers)

Client Since (Date value input by Distributor or Software Support level user)

Service Year Term (selected as either 1 or 3 year)

Service Type (text field)

Service Plan Date (Date of Contract input by Distributor or Software Support level user)

Install Date (Date of first Status Report)

Renewal Date (calculated field based on Program Start Date+Service Year Term)

Software Support Level

Similar to the distributor level interface, but includes access to all accounts.

Additional Data

See above as specified in the Distributor level

Help

The Help module includes a series of tools for assisting the user in interacting with AED MANAGER™. These tools are available to the user as a new tab in the Main Menu interface.

FAQ

User's Guide

Tutorial

FAQ

A series of frequently asked questions regarding the use of the AED MANAGER™ system.

User's Guide

A reference guide in PDF or other printable format that provides the user with a user's manual for the AED MANAGER™ system.

Tutorial

An automated presentation that walks the user through the basic steps of the AED Manger software and how to use the system to maintain their program.

User Level Distinctions

Client Level

As described above.

Distributor Level

At the Distributor level, the FAQ is expanded to answer questions specific to the Distributor interface. The User's Guide is expanded to include Distributor level content. The Tutorial remains the same as for the Client level, but may be enhanced at a later date.

Software Support Level

Mirrors the Distributor Level.

DASHBOARD

The Dashboard provides a Distributor level and Software Support level user with a quick overview of a client account presented in a single screen. The dashboard is primarily a customer support tool to be used as a quick reference when servicing an account. Data may not be entered or edited in the Dashboard interface. However, the presented data is hyperlinked to sections of the software where data may be entered/edited.

Equipment [links to installation list under Equipment tab]

Installation Names

AED Type(s)

Oxygen Type

Training [links to main page under Training tab]

Courses Completed/Oldest Certification

Number Active Team Members in Each Generic Classification

Service [links to main page under MD tab]

Medical Direction

Contract Length/End Date

of the categories is presented as a column with the designated data displayed in the appropriate column.

User Level Distinctions

Client Level

Not applicable as this module is unavailable to the Client level.

Distributor Level

As described above.

Software Support Level

As described above

Activity Log

The Activity Log is a quick view of all of the major events documented within the AED Manger. Events are logged and sorted using a date/time stamp. By clicking on an item in the list, the user may immediately access the record(s) associated with that event (i.e. an AED usage directs the user to the AED User Form filled out for the use).

User Level Distinctions

Client Level

The Client level includes only client specific activities and news items designated as being for public consumption.

Distributor Level

The Distributor level includes a feature to publish news items internally to Distributor level users exclusively. These news items appear in the Distributor level interface for Distributor level users only.

Software Support Level

The Software Support level includes a feature to publish news items internally to Software Support level users. These news items appear in the Software Support level interface for Software Support level users only.

Readiness Report

The Readiness Report is a standardized format report produced for management level oversight of an AED program. The Readiness Report provides the user with an empirical evaluation of the status of their program in a presentation-ready format.

FLES version 1.0 presented the report in the form of an automated e-mail. Version 2.0 presents the report as a .pdf file delivered via e-mail and/or on demand by the user.

There are two levels of reports—Corporate and Program Coordinator. The Corporate Report is intended for large clients with multiple instances of locations of AED installations. The Program Coordinator Report is intended for single locations with a single or multiple instance of an AED installation. The Program Coordinator Report is also available to the Program Coordinator managing a program within the framework of a corporate entity with multiple instances of locations.

Client Level Report

The Client Level Report provides an overview of the information provided in the Program Coordinator Report in metrics to allow relative and absolute evaluation of program effectiveness and value.

Equipment

Total number of AEDs installed

Average number of AEDs per location

Total number of Oxygen units installed

Average number of Oxygen units per location

Last completed Status Report date by location and installation

Training

Total number of Team Members

Average number of Team Members per Location

Matrix of Generic Course Certifications and number of team members trained at each facility (i.e. X-axis is locations, y-axis is generic course types)

Scheduled training sessions or recommended next training session by location for which they are scheduled

Average time between training sessions

Service

Total number of [AED or First Responder] incidences (based on number of reports filed)

Average time between equipment usages

The exact content of this report is provided in an addendum to this document.

Program Coordinator Report

The Program Coordinator Report provides the user with the day-to-day information required to effectively manage and maintain an AED program in the form of a monthly newsletter. This includes the following information:

AED program-relevant news story

Confirmation of last completed Status Report by installation

Reminder of next scheduled training session or recommendation for next training session

Confirmation of Trained and Active Team Members

Reminder of any expiring Team Certification(s)

Reminder of any minimum Team Member thresholds being exceeded

Reminder of supplies/accessories nearing expiration or already expired

Reminder link to local Good Samaritan legislation

The exact content of this report is provided in an addendum to this document.

User Level Distinctions

Report is made available in its standard formats at all levels.

Admin Module

Overview

The Admin Module is comprised of a series of submodules detailed in the following sections. These modules parallel closely the user interface of the Admin Menu. The Admin Menu module is used only for Distributor and Software level users. Since these users are intended to have access to multiple client accounts and each client account may have a different set of modules activated, all Admin Menu submodules are active for all Distributor and Software Support level users. When a module is inactivated at the Client level (i.e. Checklists, Equipment, Training, etc.), if a Distributor or Software level user attempts to access that section for the user, it is grayed out as it is on the Client side. At the Distributor and Software Support level, users may activate that portion by going under the client's Preferences tab and identifying the modules to activate. The same method is used in order to inactivate an active module.

Admin Menu>Clients

The Admin Menu>Clients interface for the Search and Add Client functions are similar.

[image]

Figure X.X: Screen Capture of v.1.0 Admin Menu>Clients>Search Display.

User Level Distinctions

Distributor Level

Data Model Changes

An additional Field for recording the county at the ClientSub level is required. This field drives an exception function within the Program>AED User Report and MD>Medical Director portion of the system.

For each client, the user provides an account manager for each ClientSub record. This is a required field. The Account Manager may be selected from a list of all registered users for the distributor.

Search/Add

Users may search and modify their client's records only. To each user of the system, it should appear that no records other than those of their clients are available in the database.

Software Support Level

Similar to the distributor level interface, but includes access to all accounts.

Admin Menu>Training

The Admin Menu>Training interface for search and add course are similar.

[image]

Figure X.X: Screen Capture of v.1.0 Admin Menu>News>Search Display.

User Level Distinctions

Distributor Level

As with other Admin menu functions, each distributor is able to see data only as it relates to their client base and their specific distributorship.

Software Support Level

Similar to the distributor level interface, but includes access to all accounts.

Admin Menu>News

The Admin Menu>News interface is similar for the search and for the data entry feature.

[image]

Figure X.X: Screen Capture of v.1.0 Admin Menu>News>Search Display.

User Level Distinctions

Distributor Level

As with other Admin menu functions, each distributor is able to see data only as it relates to their client base and their specific distributorship.

Software Support Level

In general, similar to the distributor level interface, but includes access to all accounts.

Low Priority Spec:

From the software support level, users are able to push stories down to the distributor as private stories (i.e., accessible only on the distributor side). At the distributor's discretion, they may change the private news to public and broadcast it to their client base.

Admin Menu>Reporting

The Reporting section remains as specified in version 1.0. The addition of the Software Support level offers new implications and additional metrics reporting in the form of a consolidated report of the data reported in the Distributor level. This data is consolidated without designating data source in order to maintain the discretion required in order to maintain the confidentiality of the Distributors.

User Level Distinctions

Distributor Level

As with other Admin menu functions, each distributor is able to see data only as it relates to their client base and their specific distributorship.

Version 2.0 of the system will offer the extended reporting of American Heart Association courses per the v. 1.0 reporting spec. No changes will be made to accommodate a different data format for other training organizations in version 2.0.

The reports types are as follows:

| | | Sample |
|---|---|---|
| Report Type | Description | Documentation |
| *Contact Report | Client Contact | Appendix M |
| | Information | |
| *Agilent HTST Market | Tracking Report to | Appendix N |
| Tracking Report | Agilent on AEDs | |
| *Agilent HSG Market | Tracking Report to | Appendix O |
| Tracking Report | Agilent on AEDs | |
| *FrontLine Product Tracking | Product Placement | Appendix P |
| Worksheet | Documentation | |
| *FrontLine Product Tracking | Internal | Appendix Q |
| Order Worksheet | Goods/Services | |
| | Notification | |
| *FrontLine Course Roster | Hand-completed POS | Appendix S |
| | data-entry form. | |
| *Life Safety Program | Listing of FrontLine | Appendix T |
| Tracking | Programs | |
| *FrontLine Client Training | Client Employees | Appendix U |
| Status | Trained and Status | |
| *American Heart Association | Tracking Report for | Appendix V |
| Tracking Report | Training to AHA | |
| Version 1.1 Feature: Client | Export to Print the | TBD |
| Record Report | Entire Client History | |
| Inventory Forecasting Report | Inventory Forecast | See Description |
| (detail below) | Based on Exp. Date | Below. |

*A copy of the format for each of these reports can be provided.

Inventory Forecasting Report

The system maintains data on expiration dates for each piece of equipment and accessories. A chron job runs against that data on a daily basis to forecast inventory needs. The system provides a list of products by polling its database. Much like an accounting package displays 30-60-90 day account status, the system provides a 30-60-90 day inventory prediction based on the expiration date of equipment still in place.

| | 30 | 60 | 90 | Total Next 90 |
|---|---|---|---|---|
| Equipment | Days | Days | Days | Days |
| FR1E | 2 (10) | 6 (15) | 19 (23) | 27 (48) |
| Batteries | | | | |
| FR1E AED | 1 (12) | 5 (13) | 15 (21) | 21 (46) |
| Pads | | | | |

The display presents two sets of numbers, one of which is in parenthesis. Since each product may be shipped with a backup supply, the chron job makes allowances for the presence of more than one unit. The first number is the number of units required to ensure that all clients have at least one of the product on hand. The number in parenthesis is the amount of inventory required in order to ensure that all clients have both a primary and backup product.

Ideally, if properly managed by the consumer and if Account Managers follow system prompts for each account, the number of 30- and 60-day needs should be minimal.

By clicking on any forecasted inventory number, the user is able to obtain a list of the clients with a need for each product.

| | | Expiration |
|---|---|---|
| Client Name | Product | Date |
| ABC Corp. | ER1E Battery | Oct. 01, 2001 |
| XYZ Corp. | FR1E Battery | Oct. 01, 2001 |

By clicking on any company name, the user is directed to the client's inventory management information (the Equipment tab within the client's Enterprise System records).

Software Support Level

In general, similar to the distributor level interface, but includes access to all accounts as a consolidated set of figures without distinction for source(s).

An additional report provides a list of installations broken down by distributor. Foundation clients (i.e. Client Side accounts with no associated distributor) are also included in this report.

This report is particularly important as it provides the basis for billing distributors and Foundation Trainers for the use of the AED MANAGER. The AED MANAGER™ will be charged on a per installation tracked basis. The exact format of this report is yet to be determined, however it would be required in an Excel format.

Admin Menu>Admin

User Level Distinctions

Distributor Level

Distributor Setup

Distributors will be expected to maintain an inventory of Enterprise accounts. This will be accomplished via the provision of a credit card type product identifying the program and providing an initial UserID/password combination. The combination is good for a single login and prompts the user to provide a new UserID/password.

The UserID/Password combinations will be provided in batches and will be assigned in the system to specific distributors. This will enable the system to immediately associate a new login with the appropriate client based on the distributor to whom the card was issued.

Distributors will have the discretion to create new accounts and authorize additional password for each of their client accounts.

Software Support Level

Similar to the distributor level interface, but includes access to all accounts.

Admin Menu>Distributor

The Distributor function is a new feature solely for the management of Distibutor level accounts and PremedicsMD inventory. This function is available ONLY to the Software Support level. Within this section the Software Support level use may establish new Distributor accounts and may reassign Client-only accounts (accounts with no associated Distributor such as those established through the AEDIF).

It is anticipated that other features may be added to this new function in order to better enable the Software Support level user.

Distributor Level Accounts

Users are able to establish Software Support level accounts and view their Client accounts. Basic Distributor contact information is collected in this interface. The data here is used to populate the drop-down box for assigning PremedicsMD inventory (see section below) and establishing a Distributor level account. In addition, the Software Support level user may search and select individual client accounts and assign them to a Distributor level account.

The interface for viewing a Distributor's Client level accounts is similar to the Corporate Client interface for viewing a summary listing of locations. By clicking on any of these clients, the Software Support level user has access to the specific Client account.

PremedicsMD Inventory

Version 2.0 will use a “credit card” or similar type of approach in providing inventory to its distributors. The card will have a serialized number and a UserID/Password combination valid for a single use. The system will prompt the user to change their serialized number and UserID/Password on initial login.

The Software Support interface allows the user to select a starting card number and ending card number and the Distributor with which that card is associated. This effectively assigns cards in lots to Distributors. Error checking prevents the duplication of an assignment of a card.

The implication of this feature is that Software Support level users will be required to establish and manage new Distributor level accounts.

Note:

Version 2.0 will not use a CD. To control costs, the expense of coding and producing a CD has been forgone in favor of the “credit card” directing the user to a web site with a UserID/Password combination. The CD may be added as a version 2.X feature in the future and be used in conjunction with the credit card. From a logistics standpoint, the card can exist without the CD, but the CD cannot exist without either a fully enabled e-commerce feature or the UserID/Password controlled credit card inventory.

Admin Menu>Preferences

General

The Client, Distributor and Software Support level each have the option to receive e-mail notification of Action Items. The system to disable Action Item notification at the Distributor and Software Support levels only.

User Level Distinctions

Distributor Level

As with other Admin menu functions, each distributor is able to see data only as it relates to their client base and their specific distributorship.

Distributor level receives escalated Action Items as a default. The Distributor level has the option to disable Action Items only if they are NOT the Medical Director.

Software Support Level

Similar to the distributor level interface, but includes access to all accounts.

The Software Support level receives escalated Action Items, only if PremedicsMD has been identified as the Medical Director for that specific location. The Software Support Level has the option to disable Action Items if they are NOT the Medical Director.

Thus, although there have been described particular embodiments of the present invention of a new and useful System and Method for Monitoring and Ensuring Proper Life Safety Equipment Maintenance, Operation, and Program Implementation, it is not intended that such references be construed as limitations upon the scope of this invention except as set forth in the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer system for managing maintenance, operation, training, and program implementation requirements associated with a device, comprising:
a database module containing maintenance requirement information for the device and actual maintenance information for the device;
a maintenance module in communication with the database module and operable to compare the maintenance requirement information and the actual maintenance information to determine if the device has been properly maintained; and
wherein the maintenance module is further operable to generate a communication indicating that the device has not been properly maintained if the maintenance module determines that the device has not been properly maintained, providing information relating to an action or actions necessary to properly maintain the device, and containing a prompt to perform the action or actions necessary to maintain the device properly.

2. The computer system of claim 1, wherein the maintenance module is further operable to facilitate performance of the action or actions necessary to properly maintain the device.

3. The computer system of claim 2, wherein:
the database module further contains operational requirement information and actual operational information for the device;
the maintenance module is operable to compare the operational requirement information and the actual operational information to determine if the device can be properly operated; and
the maintenance module is further operable to generate a communication indicating that the device can not be properly operated if the maintenance module determines that the device can not be properly operated, providing information relating to an action or actions necessary to properly operate the device, and containing a prompt to perform the action or actions necessary to operate the device properly.

4. The computer system of claim 3, wherein the maintenance module is further operable to facilitate performance of the action or actions necessary to properly operate the device.

5. The computer system of claim 4, wherein:
the database module further contains program implementation requirement information and actual program implementation information relating to a program associated with the device;
the maintenance module is operable to compare the program implementation requirement information and the actual program implementation information to determine if the program associated with the device can be properly implemented; and
the maintenance module is further operable to generate a communication indicating that the program associated with the device can not be implemented properly if the maintenance module determines that the program associated with the device can not be properly implemented, providing information relating to an action or actions necessary to properly implement the program associated with the device, and containing a prompt to perform the action or actions necessary to implement the program properly.

6. The computer system of claim 5, wherein the maintenance module is further operable to facilitate performance of the action or actions necessary to properly implement the program associated with the device.

7. The computer system of claim 6, wherein:
the operational requirement information and actual operational information includes information regarding consumables for the device;
the maintenance module determines that the device cannot be properly operated if the consumables have been exhausted or have expired usage dates.

8. The computer system of claim 7, wherein:
the operational requirement information and actual operational information includes information regarding personnel trained and certified to operate the device; and
the maintenance module determines that the device cannot be operated properly if there are no personnel trained and certified to operate the device.

9. The computer system of claim 8, wherein:
the program implementation requirement information and actual program implementation information includes information regarding personnel trained and certified to administer the program associated with the device; and
the maintenance module determines that the program associated with the device cannot be implemented properly if there are no personnel trained and certified to administer the device program.

10. The computer system of claim 9, wherein:
the maintenance requirement information includes recommended or required manufacturer maintenance requirements; and
the operational requirement information includes required manufacturer training or certification requirements.

11. The computer system of claim 10, wherein the computer system includes:
a client computer system operable to be connected to the maintenance module and the database module;
a server computer system operable to be connected to the client computer system; and
wherein the maintenance module and database module are included in the server computer system.

12. The computer system of claim 11, wherein the computer system includes:
a client computer system operable to be connected to the maintenance module and the database module via the Internet, the client computer system including a web browser module;
a server computer system operable to be connected to the client computer system via the Internet, the server computer system including a web server module; and
wherein the maintenance module and database module are included in the server computer system.

13. The computer system of claim 12, wherein the maintenance module is operable to transmit communications via email, facsimile, instant messaging, text messaging, beepers, pagers, PDAs, or any combination thereof.

14. The computer system of claim 13, wherein the device is a life safety device.

15. The computer system of claim 14, wherein the device is an automated external defibrillator.

16. The computer system of claim 13, wherein the computer system is integrated into the device.

17. A device management computer system for monitoring and ensuring proper maintenance, operation, and program implementation of a device, comprising:
a database module for storing maintenance requirement information for the device and actual maintenance information for the device, operational requirement information and actual operational information for the device, and program implementation requirement information and actual program implementation information relating to a program associated with the device;
a maintenance module in communication with the database module and operable to compare the maintenance requirement information and the actual maintenance information to determine if the device has been properly maintained, compare the operational requirement information and the actual operational information to determine if the device can be properly operated, and compare the program implementation requirement information and the actual program implementation information to determine if the program associated with the device can be properly implemented; and
wherein the maintenance module is further operable to generate a communication indicating that the device has not been properly maintained if the maintenance module determines that the device has not been properly maintained, providing information relating to an action or actions necessary to properly maintain the device, and containing a prompt to perform the action or actions necessary to maintain the device properly,
wherein the maintenance module is further operable to generate a communication indicating that the device can not be properly operated if the maintenance module determines that the device can not be properly operated, providing information relating to an action or actions necessary to properly operate the device, and containing a prompt to perform the action or actions necessary to operate the device properly, and
wherein the maintenance module is further operable to generate a communication indicating that the program associated with the device can not be implemented properly if the maintenance module determines that the program associated with the device can not be properly implemented, providing information relating to an action or actions necessary to properly implement the program associated with the device, and containing a prompt to perform the action or actions necessary to implement the program properly.

18. The device management system of claim 17, wherein the device management system includes:
a client computer system operable to be connected to the maintenance module and the database module;
a server computer system operable to be connected to the client computer system; and
wherein the maintenance module and database module are included in the server computer system.

19. The device management system of claim 18, wherein the device management system includes:
a client computer system operable to be connected to the maintenance module and the database module via the Internet, the client computer system including a web browser module;
a server computer system operable to be connected to the client computer system via the Internet, the server computer system including a web server module; and
wherein the maintenance module and database module are included in the server computer system.

20. The device management system of claim 18, wherein the maintenance module is operable to transmit communications via email, facsimile, Instant Messaging, text messaging, beepers, pagers, PDAs, or any combination thereof.

21. The device management system of claim 19, wherein the device is a life safety device.

22. The device management system of claim 20, wherein the device is an automated external defibrillator.

23. A method of monitoring and ensuring proper maintenance, operation, and program implementation requirements of an apparatus using a computer system, comprising the steps of:
storing maintenance requirement information and actual maintenance information for the apparatus in the computer system;
comparing, using the computer system, the maintenance requirement information and the actual maintenance information to determine if the apparatus has been properly maintained; and
generating a communication, using the computer system, indicating that the apparatus has not been properly maintained if the computer system determines that the apparatus has not been properly maintained, providing information relating to an action or actions necessary to properly maintain the device, and containing a prompt to perform the action or actions necessary to maintain the device properly.

24. The method of claim 23, further comprising the steps of:
storing operational requirement information and actual operational information for the apparatus in the computer system;
comparing, using the computer system, the operational requirement information and the actual operational information to determine if the apparatus can be properly operated; and
generating, using the computer system, a communication indicating that the apparatus can not be properly operated if the computer system determines that the apparatus can not be properly operated, providing information relating to an action or actions necessary to properly operate the device, and containing a prompt to perform the action or actions necessary to operate the device properly.

25. The method of claim 24, further comprising the steps of:
storing program implementation requirement information and actual program implementation information relating to a program associated with the apparatus in the computer system;
comparing, using the computer system, the program implementation requirement information and the actual program implementation information to determine if the program associated with the apparatus can be properly implemented; and
generating, using the computer system, a communication indicating that the program associated with the apparatus can not be properly implemented if the computer system determines that the program associated with the apparatus can not be properly implemented, providing information relating to an action or actions necessary to properly implement the program associated with the device, and containing a prompt to perform the action or actions necessary to implement the program properly.

26. The method of claim 25, wherein the device is a life safety device.

27. The method of claim 27, wherein the device is an automated external defibrillator.

28. A method of managing maintenance, operation, and program implementation requirements of an apparatus using a computer system, comprising the steps of:
storing, in the computer system, maintenance requirement information and actual maintenance information for the apparatus, operational requirement information and actual operational information for the apparatus, and program implementation requirement information and actual program implementation information relating to a program associated with the apparatus;
comparing, using the computer system, the maintenance requirement information and the actual maintenance information to determine if the apparatus has been properly maintained, the operational requirement information and the actual operational information to determine if the apparatus can be properly operated, and the program implementation requirement information and the actual program implementation information to determine if the program associated with the apparatus can be properly implemented; and
generating, using the computer system, a communication indicating that the device has not been properly maintained if the maintenance module determines that the device has not been properly maintained, providing information relating to an action or actions necessary to properly maintain the device, and containing a prompt to perform the action or actions necessary to maintain the device properly,
generating, using the computer system, a communication indicating that the device can not be properly operated if the maintenance module determines that the device can not be properly operated, providing information relating to an action or actions necessary to properly operate the device, and containing a prompt to perform the action or actions necessary to operate the device properly, or
generating a communication indicating that the program associated with the device can not be implemented properly if the maintenance module determines that the program associated with the device can not be properly implemented, providing information relating to an action or actions necessary to properly implement the program associated with the device, and containing a prompt to perform the action or actions necessary to implement the program properly.

29. The method of claim 28, wherein the device is a life safety device.

30. The method of claim 29, wherein the device is an automated external defibrillator.

31. A computer system for managing equipment maintenance, operation, and program implementation requirements, comprising:
a server computer system having a maintenance module, a database module, and a web server module; and
one or more client computer systems, each having a web browser module operable to communicate with the server computer system using the Internet and the web server module.

32. The computer system of claim 31, wherein the maintenance module includes a check equipment usage routine, a check equipment maintenance routine, a check equipment consumables routine, a check staff certification routine, or any combination thereof.

33. The computer system of claim 32, wherein the maintenance module further includes an implementation routine, an ordering routine, a training records routine, an equipment records routine, a staff records routine, an MD/EMS routine, a preferences routine, an action item routine, or any combination thereof.

34. The computer system of claim 33, wherein the database module includes information regarding equipment maintenance, operation, and program implementation for one or more pieces of equipment.

35. The computer system of claim 34, wherein the database module includes information regarding equipment located at one or more physical locations.

36. The computer system of claim 35, wherein the database module includes information regarding equipment associated with one or more clients.

37. The computer system of claim 36, wherein the device is a life safety device.

38. The computer system of claim 37, wherein the device is an automated external defibrillator.
